(19) United States
(12) Patent Application Publication
(10) Pub. No.: US 2012/0264889 A1
(43) Pub. Date: Oct. 18, 2012

(54) PRODUCTION PROCESS OF OLEFIN POLYMERIZATION CATALYST AND OLEFIN POLYMER

(75) Inventors: Kazuo Takaoki, Ichihara-shi (JP); Takahiro Hino, Ichihara-shi (JP)

(73) Assignee: SUMITOMO CHEMICAL COMPANY, LIMITED, Chuo-ku, Tokyo (JP)

(21) Appl. No.: 13/516,281

(22) PCT Filed: Dec. 14, 2010
(86) PCT No.: PCT/JP2010/072833

§ 371 Date: Jun. 15, 2012

(30) Foreign Application Priority Data
Dec. 15, 2009 (JP) 2009-283780
Dec. 15, 2009 (JP) 2009-283781

(51) Int. Cl. C08F 4/6592; C08F 8/06; C08F 110/02; C08F 210/14; C08F 110/06

(52) U.S. Cl. 525/333.8; 502/111; 526/114

(57) ABSTRACT

A production process of an olefin polymerization catalyst, comprising steps of (1) contacting a defined zinc compound, Zn(L¹)₂, with a defined halogenated alcohol, thereby forming a zinc atom-containing compound, and (2) contacting the zinc atom-containing compound with a defined transition metal compound and an optional organoaluminum compound; and a production process of an olefin polymer using such an olefin polymerization catalyst.

### TECHNICAL FIELD

The present invention relates to (1) a process for producing an olefin polymerization catalyst, (2) a process for producing an olefin polymer by use of the above olefin polymerization catalyst, and (3) a process for producing an olefin polymer having a hydroxyl group at its end, by use of a specific olefin polymer produced by the above production process of an olefin polymer.

### BACKGROUND ART

It is known in the art to produce a block copolymer by use of a zinc atom-containing olefin polymer with a terminal zinc atom, in order to improve properties of an olefin polymer, or in order to give a new function to an olefin polymer. For example, WO 05/090427 published on Sep. 29, 2005 discloses a process for producing a multiblock copolymer, comprising a step of polymerizing an olefin by use of a mixture containing a primary olefin polymerization catalyst, a secondary olefin polymerization catalyst, and diethyl zinc.

### DISCLOSURE OF INVENTION

However, the above production process of a multiblock copolymer using diethyl zinc has a problem that a zinc atom-containing olefin polymer with a terminal zinc atom cannot be produced in such good yield that a multiblock copolymer cannot also be produced in good yield.

In view of the above circumstances, the present invention has an object to provide (i) a process for producing an olefin polymerization catalyst, which can produce in good yield a zinc atom-containing olefin polymer with a terminal zinc atom, and (ii) a process for producing an olefin polymer using such an olefin polymerization catalyst.

The present invention is a process for producing an olefin polymerization catalyst, comprising steps of:

(1) contacting 1 part by mol of a zinc compound represented by following formula [1] with more than 0 part by mol to less than 2 parts by mol of a halogenated alcohol represented by following formula [2], thereby forming a zinc atom-containing compound; and

(2) contacting the zinc atom-containing compound with a compound of a transition metal atom of group 3 to 11 of the periodic table of elements and/or its μ-oxo type transition metal compound, and an optional organoaluminum compound;

Zn(L¹)₂ [1]

wherein L¹ is a hydrocarbyl group having 1 to 20 carbon atoms, and two L¹s are the same as, or different from each other; and

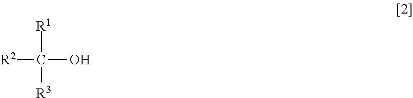

wherein R¹, R² and R³ are a hydrogen atom or a perhalocarbyl group having 1 to 20 carbon atoms, and are the same as, or different from one another; one or more of R¹, R² and R³ are the perhalocarbyl group; and any two or three of R¹, R² and R³ may be linked to one another to form a ring. This process is referred to hereinafter as “catalyst production process”.

Also, the present invention is a process for producing an olefin polymer, comprising a step of polymerizing an olefin in the presence of an olefin polymerization catalyst produced by the above process. This process is referred to hereinafter as “polymer production process”.

Further, the present invention is a process for producing an olefin polymer containing an olefin polymer which carries a hydroxyl group at its end, comprising a step of reacting a below-mentioned specific olefin with oxygen.

### BEST MODE FOR CARRYING OUT THE INVENTION

Examples of the hydrocarbyl group of L¹ in formula [1] are an alkyl group having 1 to 20 carbon atoms, an alkenyl group having 2 to 20 carbon atoms, an aryl group having 6 to 20 carbon atoms, and an aralkyl group having 7 to 20 carbon atoms.

L¹ may have a substituent such as a hydrocarbyloxy group. Examples of the hydrocarbyloxy group are an alkoxy group such as a methoxy group and an ethoxy group; an aryloxy group such as a phenoxy group; and an aralkyloxy group such as a benzyloxy group.

Examples of the above alkyl group of L¹ are a methyl group, an ethyl group, a n-propyl group, an isopropyl group, a n-butyl group, a sec-butyl group, a tert-butyl group, an isobutyl group, a n-pentyl group, a neopentyl group, a n-hexyl group, a n-heptyl group, a n-octyl group, a n-decyl group, a n-dodecyl group, a n-pentadecyl group and a n-eicosyl group. Among them, preferred is a methyl group, an ethyl group, an isopropyl group, a tert-butyl group or an isobutyl group.

Examples of the above alkenyl group of L¹ are a vinyl group, an allyl group, a propenyl group, a 2-methyl-2-propenyl group, a homoallyl group, a pentenyl group, a hexenyl group, a heptenyl group, an octenyl group, a nonenyl group, and a decenyl group.

Examples of the above aryl group of L¹ are a phenyl group, a 2-tolyl group, a 3-tolyl group, a 4-tolyl group, a 2,3-xylyl group, a 2,4-xylyl group, a 2,5-xylyl group, a 2,6-xylyl group, a 3,4-xylyl group, a 3,5-xylyl group, a 2,3,4-trimethylphenyl group, a 2,3,5-trimethylphenyl group, a 2,3,6-trimethylphenyl group, a 2,4,6-trimethylphenyl group, a 3,4,5-trimethylphenyl group, a 2,3,4,5-tetramethylphenyl group, a 2,3,4,6-tetramethylphenyl group, a 2,3,5,6-tetramethylphenyl group, a pentamethylphenyl group, an ethylphenyl group, a n-propylphenyl group, an isopropylphenyl group, a n-butylphenyl group, a sec-butylphenyl group, a tert-butylphenyl group, an isobutylphenyl group, a n-pentylphenyl group, a neopentylphenyl group, a n-hexylphenyl group, a n-octylphenyl group, a n-decylphenyl group, a n-dodecylphenyl group, a n-tetradecylphenyl group, a naphthyl group and an anthracenyl group. Among them, preferred is a phenyl group.

Examples of the above aralkyl group of L¹ are a benzyl group, a (2-methylphenyl)methyl group, a (3-methylphenyl)methyl group, a (4-methylphenyl)methyl group, a (2,3-dimethylphenyl)methyl group, a (2,4-dimethylphenyl)methyl group, a (2,5-dimethylphenyl)methyl group, a (2,6-dimethylphenyl)methyl group, a (3,4-dimethylphenyl)methyl group, a (3,5-dimethylphenyl)methyl group, a (2,3,4-trimethylphenyl)methyl group, a (2,3,5-trimethylphenyl)methyl group, a (2,3,6-trimethylphenyl)methyl group, a (3,4,5-trimethylphenyl)methyl group, a (2,4,6-trimethylphenyl)methyl group, a (2,3,4,5-tetramethylphenyl)methyl group, a (2,3,4,6-tetramethylphenyl)methyl group, a (2,3,5,6-tetramethylphenyl)methyl group, a (pentamethylphenyl)methyl group, an (ethylphenyl)methyl group, a (n-propylphenyl)methyl group, an (isopropylphenyl)methyl group, a (n-butylphenyl)methyl group, a (sec-butylphenyl)methyl group, a (tert-butylphenyl)methyl group, an (isobutylphenyl)methyl group, a (n-pentylphenyl)methyl group, a (neopentylphenyl)methyl group, a (n-hexylphenyl)methyl group, a (n-octylphenyl)methyl group, a (n-decylphenyl)methyl group, a naphthylmethyl group, and an anthracenylmethyl group. Among them, preferred is a benzyl group.

L¹ is preferably an alkyl group having 1 to 20 carbon atoms, or an aryl group having 6 to 20 carbon atoms, more preferably an alkyl group having 1 to 20 carbon atoms, further preferably a methyl group, an ethyl group, a n-propyl group, an isopropyl group, a n-butyl group, a sec-butyl group, a tert-butyl group, or an isobutyl group, and particularly preferably an ethyl group.

Examples of the zinc compound represented by formula [1] are a dialky zinc such as dimethyl zinc, diethyl zinc, di-n-propyl zinc, di-n-butyl zinc, diisobutyl zinc, and di-n-hexyl zinc; a diaryl zinc such as diphenyl zinc and dinaphthyl zinc; bis(cyclopentadienyl)zinc; and a dialkenyl zinc such as diallyl zinc. Among them, preferred is a dialky zinc, more preferred is dimethyl zinc, diethyl zinc, di-n-propyl zinc, di-n-butyl zinc, diisobutyl zinc, or di-n-hexyl zinc, further preferred is dimethyl zinc or diethyl zinc, and particularly preferred is diethyl zinc.

Examples of the perhalocarbyl group of R¹, R² and R³ in formula [2] are a perfluoromethyl group, a perfluoroethyl group, a perfluoro(n-propyl) group, a perfluoroisopropyl group, a perfluoro(n-butyl) group, a perfluoro(sec-butyl) group, a perfluoro(tert-butyl) group, a perfluoroisobutyl group, a perfluoro(n-pentyl) group, a perfluoroneopentyl group, a perfluoro(n-hexyl) group, a perfluoro(n-heptyl) group, a perfluoro(n-octyl) group, a perfluoro(n-decyl) group, a perfluoro(n-dodecyl) group, a perfluoro(n-pentadecyl) group, and a perfluoro(n-eicosyl) group; and perhalocarbyl groups obtained by changing “fluoro” in the above groups to “chloro”, “bromo” or “iodo”.

The perhalocarbyl group is preferably a perfluorocarbyl group. The perfluorocarbyl group is preferably a perfluorocarbyl group having 1 to 6 carbon atoms, more preferably a perfluoromethyl group, a perfluoroethyl group, a perfluoro(n-propyl) group, a perfluoroisopropyl group, a perfluoro(n-butyl) group, a perfluoro(sec-butyl) group, a perfluoro(tert-butyl) group, or a perfluoroisobutyl group, further preferably a perfluoromethyl group, a perfluoroethyl group, a perfluoroisopropyl group, or a perfluoro(tert-butyl) group, particularly preferably a perfluoromethyl group, a perfluoroethyl group, or a perfluoroisopropyl group, and most preferably a perfluoromethyl group or a perfluoroethyl group.

Examples of the halogenated alcohol represented by formula [2] are perfluoro(trimethyl)carbinol, which is also referred to as perfluoro-tert-butyl alcohol or 1,1-bis(trifluoromethyl)-2,2,2-trifluoroethanol, perfluoro(dimethylethyl)carbinol, perfluoro(diethylmethyl)carbinol, perfluoro(dimethylisopropyl)carbinol, perfluoro(triethyl)carbinol, perfluoro(ethylmethylisopropyl)carbinol, perfluoro(tert-butyldimethyl)carbinol, perfluoro(diethylisopropyl)carbinol, perfluoro(diisopropylmethyl)carbinol, perfluoro(tert-butylethylmethyl)carbinol, perfluoro(diisopropylethyl)carbinol, perfluoro(tert-butylisopropylmethyl)carbinol, perfluoro(tert-butyldiethyl)carbinol, perfluoro(triisopropyl)carbinol, perfluoro(tert-butylethylisopropyl)carbinol, perfluoro(di-tert-butylmethyl)carbinol, perfluoro(tert-butyldiisopropyl)carbinol, perfluoro(di-tert-butylethyl)carbinol, perfluoro(di-tert-butylisopropyl)carbinol, and perfluoro(tri-tert-butyl)carbinol. Among them, preferred is perfluoro(trimethyl)carbinol, perfluoro(dimethylethyl)carbinol, perfluoro(diethylmethyl)carbinol, perfluoro(dimethylisopropyl)carbinol, perfluoro(triethyl)carbinol, perfluoro(ethylmethylisopropyl)carbinol, perfluoro(diethylisopropyl)carbinol, perfluoro(diisopropylmethyl)carbinol, perfluoro(diisopropylethyl)carbinol, or perfluoro(triisopropyl)carbinol, and more preferred is perfluoro(trimethyl)carbinol, perfluoro(dimethylethyl)carbinol, perfluoro(diethylmethyl)carbinol, or perfluoro(triethyl)carbinol.

The contact of the zinc compound represented by formula [1] with the halogenated alcohol represented by formula [2] is carried out preferably in an atmosphere of inert gas, with or without a solvent. Contact temperature is usually −100 to 300° C., and preferably −80 to 200° C. Contact time is usually 1 minute to 200 hours, and preferably 10 minutes to 100 hours. As the above solvent, there are used a solvent inert to the zinc compound, the halogenated alcohol and a contact product thereof. Examples of the solvent are a non-polar solvent such as an aliphatic hydrocarbon solvent, an alicyclic hydrocarbon solvent, and an aromatic hydrocarbon solvent; and a polar solvent such as a halide solvent, an ether solvent, a carbonyl compound solvent, a phosphoric acid derivative solvent, a nitrile compound solvent, a nitro compound solvent, an amine solvent, and a sulfur compound solvent. Among them, preferred is an aliphatic hydrocarbon solvent, an alicyclic hydrocarbon solvent, an aromatic hydrocarbon solvent, or an ether solvent.

Examples of the above aliphatic hydrocarbon solvent are butane, pentane, hexane, heptane, octane, and 2,2,4-trimethylpentane. An example of the above alicyclic hydrocarbon solvent is cyclohexane. Examples of the above aromatic hydrocarbon solvent are benzene, toluene and xylene. Examples of the above halide solvent are dichloromethane, difluoromethane, chloroform, 1,2-dichloroethane, 1,2-dibromoethane, 1,1,2-trichloro-1,2,2-trifluoroethane, tetrachloroethylene, chlorobenzene, bromobenzene and o-dichlorobenzene. Examples of the above ether solvent are dimethyl ether, diethyl ether, diisopropyl ether, di-n-butyl ether, methyl-tert-butyl ether, anisole, 1,4-dioxane, 1,2-dimethoxyethane, bis(2-methoxyethyl)ether, tetrahydrofuran and tetrahydropyran. Examples of the above carbonyl compound solvent are acetone, ethyl methyl ketone, cyclohexanone, acetic anhydride, ethyl acetate, butyl acetate, ethylene carbonate, propylene carbonate, N,N-dimethylformamide, N,N-dimethylacetamide and N-methyl-2-pyrrolidone. Examples of the above phosphoric acid derivative solvent are hexamethylphosphate triamide and triethyl phosphate. Examples of the above nitrile compound solvent are acetonitrile, propionitrile, succinonitrile and benzonitrile. Examples of the above nitro compound solvent are nitromethane and nitrobenzene. Examples of the above amine solvent are pyridine, piperidine and morpholine. Examples of the above sulfur compound solvent are dimethylsulfoxide and sulfolane.

The halogenated alcohol represented by formula [2] is used in an amount of more than 0 to less than 2 mol, preferably 0.2 to 1.8 mol, more preferably 0.4 to 1.6 mol, further preferably 0.6 to 1.4 mol, particularly preferably 0.8 to 1.2 mol, and most preferably 0.9 to 1.1 mol, per 1 mol of the zinc compound represented by formula [1].

A zinc atom-containing compound formed by the contact of the zinc compound with the halogenated alcohol is preferably washed to remove starting compounds, although the zinc atom-containing compound may contain those starting compounds. A solvent for such washing is the same as, or different from the above solvent used for the contact. Such washing is carried out preferably in an atmosphere of inert gas, at usually −100 to 300° C., and preferably −80 to 200° C., and for usually 1 minute to 200 hours, and preferably 10 minutes to 100 hours.

After distilling away volatile matters from the formed zinc atom-containing compound, the zinc atom-containing compound is preferably dried under reduced pressure, preferably at 0° C. or higher for 1 to 24 hours, more preferably at 0 to 200° C. for 1 to 24 hours, further preferably at 10 to 200° C. for 1 to 24 hours, particularly preferably at 10 to 160° C. for 1 to 18 hours, and most preferably at 15 to 160° C. for 1 to 18 hours.

The following is an explanation of a process for producing a zinc atom-containing compound, by use of diethyl zinc as the zinc compound, and 1,1-bis(trifluoromethyl)-2,2,2-trifluoroethanol as the halogenated alcohol. The process comprises steps of (i) adding a hexane solution of diethyl zinc to toluene (solvent), (ii) cooling the resultant mixture down to 0° C., (iii) adding drop-wise the same molar amount of 1,1-bis(trifluoromethyl)-2,2,2-trifluoroethanol as that of diethyl zinc to the mixture, (iv) stirring the mixture at 0° C. for 10 minutes to 3 hours, (v) further stirring the mixture at 20 to 40° C. for 10 minutes to 24 hours, (vi) distilling away under reduced pressure volatile matters from the obtained reaction mixture, and (vii) drying the resultant material at room temperature under reduced pressure for 1 to 20 hours, thereby obtaining a zinc atom-containing compound.

The zinc atom-containing compound in the present invention is preferably a compound represented by following formula [3] and/or its associate:

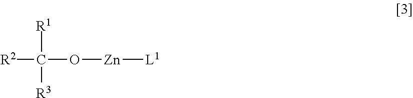

wherein R¹, R² and R³ are the same as those in formula [2], respectively; and L¹ is a hydrocarbyl group having 1 to 20 carbon atoms.

Examples of the hydrocarbyl group of L¹ are the same as those of L¹ mentioned above.

Examples of the compound represented by formula [3] are methyl{perfluoro(trimethyl)carbyloxy}zinc,
methyl{perfluoro(dimethylethyl)carbyloxy}zinc,
methyl{perfluoro(diethylmethyl)carbyloxy}zinc,
methyl{perfluoro(dimethylisopropyl)carbyloxy}zinc,
methyl{perfluoro(triethyl)carbyloxy}zinc,
methyl{perfluoro(ethylmethylisopropyl)carbyloxy}zinc,
methyl{perfluoro(tert-butyldimethyl)carbyloxy}zinc,
methyl{perfluoro(diethylisopropyl)carbyloxy}zinc,
methyl{perfluoro(diisopropylmethyl)carbyloxy}zinc,
methyl{perfluoro(tert-butylethylmethyl)carbyloxy}zinc,
methyl{perfluoro(diisopropylethyl)carbyloxy}zinc,
methyl{perfluoro(tert-butylisopropylmethyl)carbyloxy}zinc,
methyl{perfluoro(tert-butyldiethyl)carbyloxy}zinc,
methyl{perfluoro(triisopropyl)carbyloxy}zinc,
methyl{perfluoro(tert-butylethylisopropyl)carbyloxy}zinc,
methyl{perfluoro(di-tert-butylmethyl)carbyloxy}zinc,
methyl{perfluoro(tert-butyldiisopropyl)carbyloxy}zinc,
methyl{perfluoro(di-tert-butylethyl)carbyloxy}zinc,
methyl{perfluoro(di-tert-butylisopropyl)carbyloxy}zinc,
methyl{perfluoro(tri-tert-butyl)carbyloxy}zinc,
ethyl{perfluoro(trimethyl)carbyloxy}zinc,
ethyl{perfluoro(dimethylethyl)carbyloxy}zinc,
ethyl{perfluoro(diethylmethyl)carbyloxy}zinc,
ethyl{perfluoro(dimethylisopropyl)carbyloxy}zinc,
ethyl{perfluoro(triethyl)carbyloxy}zinc,
ethyl{perfluoro(ethylmethylisopropyl)carbyloxy}zinc,
ethyl{perfluoro(tert-butyldimethyl)carbyloxy}zinc,
ethyl{perfluoro(diethylisopropyl)carbyloxy}zinc,
ethyl{perfluoro(diisopropylmethyl)carbyloxy}zinc,
ethyl{perfluoro(tert-butylethylmethyl)carbyloxy}zinc,
ethyl{perfluoro(diisopropylethyl)carbyloxy}zinc,
ethyl{perfluoro(tert-butylisopropylmethyl)carbyloxy}zinc,
ethyl{perfluoro(tert-butyldiethyl)carbyloxy}zinc,
ethyl{perfluoro(triisopropyl)carbyloxy}zinc,
ethyl{perfluoro(tert-butylethylisopropyl)carbyloxy}zinc,
ethyl{perfluoro(di-tert-butylmethyl)carbyloxy}zinc,
ethyl{perfluoro(tert-butyldiisopropyl)carbyloxy}zinc,
ethyl{perfluoro(di-tert-butylethyl)carbyloxy}zinc,
ethyl{perfluoro(di-tert-butylisopropyl)carbyloxy}zinc,
ethyl{perfluoro(tri-tert-butyl)carbyloxy}zinc,
n-propyl{perfluoro(trimethyl)carbyloxy}zinc,
n-propyl{perfluoro(dimethylethyl)carbyloxy}zinc,
n-propyl{perfluoro(diethylmethyl)carbyloxy}zinc,
n-propyl{perfluoro(dimethylisopropyl)carbyloxy}zinc,
n-propyl{perfluoro(triethyl)carbyloxy}zinc,
n-propyl{perfluoro(ethylmethylisopropyl)carbyloxy}zinc,
n-propyl{perfluoro(tert-butyldimethyl)carbyloxy}zinc,
n-propyl{perfluoro(diethylisopropyl)carbyloxy}zinc,
n-propyl{perfluoro(diisopropylmethyl)carbyloxy}zinc,
n-propyl{perfluoro(tert-butylethylmethyl)carbyloxy}zinc,
n-propyl{perfluoro(diisopropylethyl)carbyloxy}zinc,
n-propyl{perfluoro(tert-butylisopropylmethyl)carbyloxy}zinc,
n-propyl{perfluoro(tert-butyldiethyl)carbyloxy}zinc,
n-propyl{perfluoro(triisopropyl)carbyloxy}zinc,
n-propyl{perfluoro(tert-butylethylisopropyl)carbyloxy}zinc,
n-propyl{perfluoro(di-tert-butylmethyl)carbyloxy}zinc,
n-propyl{perfluoro(tert-butyldiisopropyl)carbyloxy}zinc,
n-propyl{perfluoro(di-tert-butylethyl)carbyloxy}zinc,
n-propyl{perfluoro(di-tert-butylisopropyl)carbyloxy}zinc,
n-propyl{perfluoro(tri-tert-butyl)carbyloxy}zinc,
n-butyl{perfluoro(trimethyl)carbyloxy}zinc,
n-butyl{perfluoro(dimethylethyl)carbyloxy}zinc,
n-butyl{perfluoro(diethylmethyl)carbyloxy}zinc,
n-butyl{perfluoro(dimethylisopropyl)carbyloxy}zinc,
n-butyl{perfluoro(triethyl)carbyloxy}zinc,
n-butyl{perfluoro(ethylmethylisopropyl)carbyloxy}zinc,
n-butyl{perfluoro(tert-butyldimethyl)carbyloxy}zinc,
n-butyl{perfluoro(diethylisopropyl)carbyloxy}zinc,
n-butyl{perfluoro(diisopropylmethyl)carbyloxy}zinc,
n-butyl{perfluoro(tert-butylethylmethyl)carbyloxy}zinc,
n-butyl{perfluoro(diisopropylethyl)carbyloxy}zinc,
n-butyl{perfluoro(tert-butylisopropylmethyl)carbyloxy}zinc,
n-butyl{perfluoro(tert-butyldiethyl)carbyloxy}zinc,
n-butyl{perfluoro(triisopropyl)carbyloxy}zinc,
n-butyl{perfluoro(tert-butylethylisopropyl)carbyloxy}zinc,
n-butyl{perfluoro(di-tert-butylmethyl)carbyloxy}zinc,
n-butyl{perfluoro(tert-butyldiisopropyl)carbyloxy}zinc,
n-butyl{perfluoro(di-tert-butylethyl)carbyloxy}zinc,
n-butyl{perfluoro(di-tert-butylisopropyl)carbyloxy}zinc,
n-butyl{perfluoro(tri-tert-butyl)carbyloxy}zinc,
isobutyl{perfluoro(trimethyl)carbyloxy}zinc,
isobutyl{perfluoro(dimethylethyl)carbyloxy}zinc,
isobutyl{perfluoro(diethylmethyl)carbyloxy}zinc,
isobutyl{perfluoro(dimethylisopropyl)carbyloxy}zinc,
isobutyl{perfluoro(triethyl)carbyloxy}zinc,
isobutyl{perfluoro(ethylmethylisopropyl)carbyloxy}zinc,
isobutyl{perfluoro(tert-butyldimethyl)carbyloxy}zinc,
isobutyl{perfluoro(diethylisopropyl)carbyloxy}zinc,
isobutyl{perfluoro(diisopropylmethyl)carbyloxy}zinc,
isobutyl{perfluoro(tert-butylethylmethyl)carbyloxy}zinc,
isobutyl{perfluoro(diisopropylethyl)carbyloxy}zinc,
isobutyl{perfluoro(tert-butylisopropylmethyl)carbyloxy}zinc,
isobutyl{perfluoro(tert-butyldiethyl)carbyloxy}zinc,
isobutyl{perfluoro(triisopropyl)carbyloxy}zinc,
isobutyl{perfluoro(tert-butylethylisopropyl)carbyloxy}zinc,
isobutyl{perfluoro(di-tert-butylmethyl)carbyloxy}zinc,
isobutyl{perfluoro(tert-butyldiisopropyl)carbyloxy}zinc,
isobutyl{perfluoro(di-tert-butylethyl)carbyloxy}zinc,
isobutyl{perfluoro(di-tert-butylisopropyl)carbyloxy}zinc,
isobutyl{perfluoro(tri-tert-butyl)carbyloxy}zinc,
n-hexyl{perfluoro(trimethyl)carbyloxy}zinc,
n-hexyl{perfluoro(dimethylethyl)carbyloxy}zinc,
n-hexyl{perfluoro(diethylmethyl)carbyloxy}zinc,
n-hexyl{perfluoro(dimethylisopropyl)carbyloxy}zinc,
n-hexyl{perfluoro(triethyl)carbyloxy}zinc,
n-hexyl{perfluoro(ethylmethylisopropyl)carbyloxy}zinc,
n-hexyl{perfluoro(tert-butyldimethyl)carbyloxy}zinc,
n-hexyl{perfluoro(diethylisopropyl)carbyloxy}zinc,
n-hexyl{perfluoro(diisopropylmethyl)carbyloxy}zinc,
n-hexyl{perfluoro(tert-butylethylmethyl)carbyloxy}zinc,
n-hexyl{perfluoro(diisopropylethyl)carbyloxy}zinc,
n-hexyl{perfluoro(tert-butylisopropylmethyl)carbyloxy}zinc,
n-hexyl{perfluoro(tert-butyldiethyl)carbyloxy}zinc,
n-hexyl{perfluoro(triisopropyl)carbyloxy}zinc,
n-hexyl{perfluoro(tert-butylethylisopropyl)carbyloxy}zinc,
n-hexyl{perfluoro(di-tert-butylmethyl)carbyloxy}zinc,
n-hexyl{perfluoro(tert-butyldiisopropyl)carbyloxy}zinc,
n-hexyl{perfluoro(di-tert-butylethyl)carbyloxy}zinc,
n-hexyl{perfluoro(di-tert-butylisopropyl)carbyloxy}zinc,
   and n-hexyl{perfluoro(tri-tert-butyl)carbyloxy}zinc.

Among them, preferred is
methyl{perfluoro(trimethyl)carbyloxy}zinc,
methyl{perfluoro(dimethylethyl)carbyloxy}zinc,
methyl{perfluoro(diethylmethyl)carbyloxy}zinc,
methyl{perfluoro(dimethylisopropyl)carbyloxy}zinc,
methyl{perfluoro(triethyl)carbyloxy}zinc,
methyl{perfluoro(ethylmethylisopropyl)carbyloxy}zinc,
methyl{perfluoro(tert-butyldimethyl)carbyloxy}zinc,
methyl{perfluoro(diethylisopropyl)carbyloxy}zinc,
methyl{perfluoro(diisopropylmethyl)carbyloxy}zinc,
methyl{perfluoro(tert-butylethylmethyl)carbyloxy}zinc,
methyl{perfluoro(diisopropylethyl)carbyloxy}zinc,
methyl{perfluoro(tert-butylisopropylmethyl)carbyloxy}zinc,
methyl{perfluoro(tert-butyldiethyl)carbyloxy}zinc,
methyl{perfluoro(triisopropyl)carbyloxy}zinc,
methyl{perfluoro(tert-butylethylisopropyl)carbyloxy}zinc,
methyl{perfluoro(di-tert-butylmethyl)carbyloxy}zinc,
methyl{perfluoro(tert-butyldiisopropyl)carbyloxy}zinc,
methyl{perfluoro(di-tert-butylethyl)carbyloxy}zinc,
methyl{perfluoro(di-tert-butylisopropyl)carbyloxy}zinc,
methyl{perfluoro(tri-tert-butyl)carbyloxy}zinc,
ethyl{perfluoro(trimethyl)carbyloxy}zinc,
ethyl{perfluoro(dimethylethyl)carbyloxy}zinc,
ethyl{perfluoro(diethylmethyl)carbyloxy}zinc,
ethyl{perfluoro(dimethylisopropyl)carbyloxy}zinc,
ethyl{perfluoro(triethyl)carbyloxy}zinc,
ethyl{perfluoro(ethylmethylisopropyl)carbyloxy}zinc,
ethyl{perfluoro(diethylisopropyl)carbyloxy}zinc,
ethyl{perfluoro(diisopropylmethyl)carbyloxy}zinc,
ethyl{perfluoro(diisopropylethyl)carbyloxy}zinc, or
ethyl{perfluoro(triisopropyl)carbyloxy}zinc.

More preferred is
ethyl{perfluoro(trimethyl)carbyloxy}zinc,
ethyl{perfluoro(dimethylethyl)carbyloxy}zinc,
ethyl{perfluoro(diethylmethyl)carbyloxy}zinc,
ethyl{perfluoro(dimethylisopropyl)carbyloxy}zinc,
ethyl{perfluoro(triethyl)carbyloxy}zinc,
ethyl{perfluoro(ethylmethylisopropyl)carbyloxy}zinc,
ethyl{perfluoro(diethylisopropyl)carbyloxy}zinc,
ethyl{perfluoro(diisopropylmethyl)carbyloxy}zinc,
ethyl{perfluoro(diisopropylethyl)carbyloxy}zinc, or
ethyl{perfluoro(triisopropyl)carbyloxy}zinc;
   and further preferred is ethyl{perfluoro(trimethyl)carbyloxy}zinc,
ethyl{perfluoro(dimethylethyl)carbyloxy}zinc,
ethyl{perfluoro(diethylmethyl)carbyloxy}zinc, or
ethyl{perfluoro(triethyl)carbyloxy}zinc.

The above associate of a zinc atom-containing compound represented by formula [3] means an aggregate of two or more structural units, provided that a structure represented by formula [3] means one structural unit. Examples of the associate are compounds represented by following formula [5] or [6].

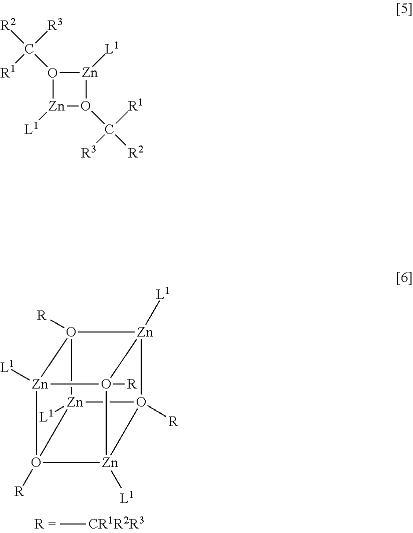

The zinc atom-containing compound may be supported on a carrier. The carrier is preferably a porous material having a uniform particle diameter, and particularly preferably an inorganic material or an organic polymer.

Examples of such inorganic material are an inorganic oxide and a magnesium compound. An inorganic oxide such as clay and clay mineral can also be used as a carrier. Those materials may be used in combination of two or more thereof.

Examples of the inorganic oxide are SiO₂, Al₂O₂, MgO, ZrO₂, TiO₂, B₂O₃, CaO, ZnO, BaO and ThO₂, and a mixture of two or more thereof such as SiO₂—MgO, SiO₂—Al₂O₂, SiO₂—TiO₂, SiO₂—V₂O₅, SiO₂—Cr₂O₃ and SiO₂—TiO₂—MgO. Among them, preferred is SiO₂, Al₂O₂, or a combination of SiO₂ with Al₂O₂. Those inorganic oxides may contain a small amount of carbonates, sulfates, nitrates or oxides such as Na₂CO₂, K₂CO₃, CaCO₃, MgCO₃, Na₂SO₄, Al₂(SO₄)₂, BaSO₄, KNO₃, Mg(NO₂)₂, Al(NO₂)₂, Na₂O, K₂O and Li₂O.

Examples of the above magnesium compound are a magnesium halide such as magnesium chloride, magnesium bromide, magnesium iodide, and magnesium fluoride; an alkoxymagnesium halide such as methoxymagnesium chloride, ethoxymagnesium chloride, isopropoxymagnesium chloride, butoxymagnesium chloride, and octoxymagnesium chloride; an aryloxymagnesium halide such as phenoxymagnesium chloride and methylphenoxymagnesium chloride; an alkoxymagnesium such as ethoxymagnesium, isopropoxymagnesium, butoxymagnesium, n-octoxymagnesium, and 2-ethylhexoxymagnesium; an aryloxymagnesium such as phenoxymagnesium and dimethylphenoxymagnesium; and a magnesium carboxylate such as magnesium laurate and magnesium stearate. Among them, preferred is a magnesium halide or an alkoxymagnesium, and further preferred is magnesium chloride or butoxymagnesium.

Examples of above clay and clay mineral are kaolin, bentonite, kibushi clay, gaerome clay, allophane, hisingerite, pyrophylite, talc, a mica group, smectite, hectorite, raponite, saponite, a montmorillonite group, vermiculite, a chlorite group, palygorskite, kaolinite, nacrite, dickite, and halloycite. Among them, preferred is smectite, montmorillonite, hectorite, raponite or saponite, and further preferred is montmorillonite or hectorite.

The above inorganic material is preferably dried by heating, at usually 100 to 1,500° C., preferably 100 to 1,000° C., and further preferably 200 to 800° C. Examples of such a drying method by heating are (i) a method of applying dried inert gas (for example, nitrogen gas and argon gas) to a heated inorganic material, for a couple of hours or more at a constant flow rate, and (ii) a method of exposing a heated inorganic material to a vacuum for a couple of hours.

The above inorganic material has an average particle diameter of preferably 5 to 1,000 μm, more preferably 10 to 500 μm, and further preferably 10 to 100 μm, has a pore volume of preferably 0.1 mL/g or more, and more preferably 0.3 to 10 mL/g, and has a specific surface area of preferably 10 to 1,000 m²/g, and more preferably 100 to 500 m²/g.

The above organic polymer is not particularly limited in its kind, and may be a combination of two or more kinds of organic polymers. The organic polymer has preferably a non-proton-donating Lewis basic functional group, which means a Lewis basic functional group donating no proton.

Such a non-proton-donating Lewis basic functional group is not particularly limited, as long as it has a Lewis basic part having no active hydrogen atom. Examples of the non-proton-donating Lewis basic functional group are a pyridyl group, an N-substituted imidazolyl group, an N-substituted indazolyl group, a nitrile group, an azido group, an N-substituted imino group, an N,N-substituted amino group, an N,N-substituted aminoxy group, an N,N,N-substituted hydrazino group, a nitroso group, a nitro group, a nitroxy group, a furyl group, a carbonyl group, a thiocarbonyl group, an alkoxy group, an alkyloxycarbonyl group, an N,N-substituted carbamoyl group, a thioalkoxy group, a substituted sulfinyl group, a substituted sulfonyl group, and a substituted sulfonic acid group. Among them, preferred is a heterocyclic group; more preferred is an aromatic heterocyclic group having an oxygen atom and/or nitrogen atom in its ring; particularly preferred is a pyridyl group, an N-substituted imidazolyl group, or an N-substituted indazoyl group; and most preferred is a pyridyl group. Those groups may be substituted with a halogen atom, or a hydrocarbyl group having 1 to 20 carbon atoms.

The non-proton-donating Lewis basic functional group contained in an organic polymer is not particularly limited in its amount. The amount by mol per 1 g of the organic polymer is preferably 0.01 to 50 mmol/g, and more preferably 0.1 to 20 mmol/g.

Such an organic polymer having a non-proton-donating Lewis basic functional group can be produced, for example, (i) by homopolymerizing a monomer having both a non-proton-donating Lewis basic functional group and one or more polymerizable unsaturated groups, or (ii) by copolymerizing such a monomer with other monomer having one or more polymerizable unsaturated groups. These monomers are preferably combined with a crosslinkable monomer having two or more polymerizable unsaturated groups, such as divinylbenzene.

Examples of the above monomer having a non-proton-donating Lewis basic functional group and one or more polymerizable unsaturated groups are those having one of above-exemplified functional groups such as a pyridyl group, and one or more polymerizable unsaturated groups. Examples of the polymerizable unsaturated group are an alkenyl group such as a vinyl group and an allyl group; and an alkynyl group such as an ethyne group.

Examples of the monomer having a non-proton-donating Lewis basic functional group and one or more polymerizable unsaturated groups are vinylpyridine, vinyl(N-substituted)imidazole and vinyl(N-substituted)indazole.

Examples of above-mentioned other monomer having one or more polymerizable unsaturated groups are ethylene; an α-olefin such as propylene, butene-1, hexene-1 and 4-methyl-pentene-1; an aromatic vinyl compound such as styrene; and a combination of two or more thereof. Among them, preferred is ethylene or styrene.

The above organic polymer has an average particle diameter of preferably 5 to 1,000 μm, and more preferably 10 to 500 μm, has a pore volume of preferably 0.1 mL/g or more, and more preferably 0.3 to 10 mL/g, and has a specific surface area of preferably 10 to 1,000 m²/g, and more preferably 50 to 500 m²/g.

A transition metal compound in the present invention is preferably a compound represented by following formula [7] and/or its μ-oxo type transition metal compound:

(L²)_{a-b}M¹(X¹)_{b} [7]

wherein M¹ is a transition metal atom of group 3 to 11 of the periodic table of elements (IUPAC, 1989); L² is a cyclopentadiene-containing anionic group having 5 to 30 carbon atoms, or a hetero atom-containing group, and when two or more L²s exist, they are the same as, or different from one another, and they may be linked to one another directly or through a linking group containing a carbon atom, a silicone atom, a nitrogen atom, an oxygen atom, a sulfur atom or a phosphorus atom; X¹ is a halogen atom, a hydrocarbyl group having 1 to 20 carbon atoms, or a hydrocarbyloxy group having 1 to 20 carbon atoms, and when two or more X¹s exist, they are the same as, or different from one another, and one or more thereof are the hydrocarbyl group having 1 to 20 carbon atoms; a is a valence of M¹; and b is an integer of 1 to (a-1).

Examples of M¹ are a titanium atom, a zirconium atom, a hafnium atom, a vanadium atom, a niobium atom, a tantalum atom, a chromium atom, an iron atom, a ruthenium atom, a cobalt atom, a rhodium atom, a nickel atom, and a palladium atom. Among them, preferred is a transition metal atom of group 4, more preferred is a titanium atom, a zirconium atom, or a hafnium atom, and further preferred is a zirconium atom.

Examples of the above cyclopentadiene-containing anionic group having 5 to 30 carbon atoms of L² are a cyclopentadienyl group, a substituted cyclopentadienyl group, an indenyl group, a substituted indenyl group, a fluorenyl group, and a substituted fluorenyl group. Examples of the cyclopentadiene-containing anionic group are a η⁵-(substituted)cyclopentadienyl group, a η⁵-(substituted)indenyl group, and a η⁵-(substituted)fluorenyl group.

Specific examples of the cyclopentadiene-containing anionic group are an η⁵-cyclopentadienyl group, an η⁵-methylcyclopentadienyl group, an η⁵-tert-butylcyclopentadienyl group, an η⁵-1,2-dimethylcyclopentadienyl group, an η⁵-1,3-dimethylcyclopentadienyl group, an η⁵-1-tert-butyl-2-methylcyclopentadienyl group, an η⁵-1-tert-butyl-3-methylcyclopentadienyl group, an η⁵-1-methyl-2-isopropylcyclopentadienyl group, an η⁵-1-methyl-3-isopropylcyclopentadienyl group, an η⁵-1,2,3-trimethylcyclopentadienyl group, an η⁵-1,2,4-trimethylcyclopentadienyl group, an η⁵-tetramethylcyclopentadienyl group, an η⁵-pentamethylcyclopentadienyl group, an η⁵-indenyl group, an η⁵-4,5,6,7-tetrahydroindenyl group, an η⁵-2-methylindenyl group, an η⁵-3-methylindenyl group, an η⁵-4-methylindenyl group, an η⁵-5-methylindenyl group, an η⁵-6-methylindenyl group, an η⁵-7-methylindenyl group, an η⁵-2-tert-butylindenyl group, an η⁵-3-tert-butylindenyl group, an η⁵-4-tert-butylindenyl group, an η⁵-5-tert-butylindenyl group, an η⁵-6-tert-butylindenyl group, an η⁵-7-tert-butylindenyl group, an η⁵-2,3-dimethylindenyl group, an η⁵-4,7-dimethylindenyl group, an η⁵-2,4,7-trimethylindenyl group, an η⁵-2-methyl-4-isopropylindenyl group, an η⁵-4,5-benzindenyl group, an η⁵-2-methyl-4,5-benzindenyl group, an η⁵-4-phenylindenyl group, an η⁵-2-methyl-5-phenylindenyl group, an η⁵-2-methyl-4-phenylindenyl group, an η⁵-2-methyl-4-naphthylindenyl group, an η⁵-fluorenyl group, an η⁵-2,7-dimethylfluorenyl group, and an η⁵-2,7-di-tert-butylfluorenyl group; and substitutions of those groups, for example, those groups substituted with a methyl group.

Examples of the above hetero atom contained in the hetero atom-containing group of L² are an oxygen atom, a sulfur atom, a nitrogen atom, and a phosphorus atom. Examples of the hetero atom-containing group are an alkoxy group, an aryloxy group, a thioalkoxy group, a thioaryloxy group, an alkylamino group, an arylamino group, an alkylphosphino group, and an arylphosphino group. Further examples of the hetero atom-containing group are an aromatic or aliphatic heterocyclic group containing an oxygen atom, a sulfur atom, a nitrogen atom, or a phosphorus atom in its ring, and a chelating ligand.

Specific examples of the hetero atom-containing group are a methoxy group, an ethoxy group, a propoxy group, a butoxy group, a phenoxy group, a 2-methylphenoxy group, a 2,6-dimethylphenoxy group, a 2,4,6-trimethylphenoxy group, a 2-ethylphenoxy group, a 4-n-propylphenoxy group, a 2-isopropylphenoxy group, a 2,6-diisopropylphenoxy group, a 4-sec-butylphenoxy group, a 4-tert-butylphenoxy group, a 2,6-di-sec-butylphenoxy group, a 2-tert-butyl-4-methylphenoxy group, a 2,6-di-tert-butylphenoxy group, a 4-methoxyphenoxy group, a 2,6-dimethoxyphenoxy group, a 3,5-dimethoxyphenoxy group, a 2-chlorophenoxy group, a 4-nitrosophenoxy group, a 4-nitrophenoxy group, a 2-aminophenoxy group, a 3-aminophenoxy group, a 4-aminothiophenoxy group, a 2,3,6-trichlorophenoxy group, a 2,4,6-trifluorophenoxy group, a thiomethoxy group, a dimethylamino group, a diethylamino group, a dipropylamino group, a diphenylamino group, an isopropylamino group, a tert-butylamino group, a pyrrolyl group, a dimethylphosphino group, a 2-(2-oxy-1-propyl)phenoxy group, a 1,2-benzenedioxy group, a 1,3-benzenedioxy group, a 4-isopropyl-1,2-benzenedioxy group, a 3-methoxy-1,2-benzenedioxy group, a 1,8-dihydroxynahpthyl group, a 1,2-dihydroxynahpthyl group, a 2,2′-biphenyldioxy group, a 1,1′-binaphthyl-2,2′-dioxy group, a 2,2′-dihydroxy-6,6′-dimethylbiphenyl group, a 4,4′,6,6′-tetra-tert-butyl-2,2′-methylenediphenoxy group, and a 4,4′,6,6′-tetramethyl-2,2′-isobutylidenediphenoxy group.

The group represented by following formula [8] is also an example of the hetero atom-containing group:

R¹⁰₃P═N——— [8]

wherein ——— is a bond to M¹; R¹⁰ is a hydrogen atom, a halogen atom, or a hydrocarbyl group having 1 to 20 carbon atoms; three R¹⁰s are the same as, or different from one another; and any two of three R¹⁰s may be linked to each other to form a ring.

Examples of the halogen atom of R¹⁰ are a fluorine atom, a chlorine atom, a bromine atom, an iodine atom. Examples of the hydrocarbyl group of R¹⁰ are a methyl group, an ethyl group, a n-propyl group, an isopropyl group, a n-butyl group, a tert-butyl group, a cyclopropyl group, a cyclobutyl group, a cycloheptyl group, a cyclohexyl group, a phenyl group, a 1-naphthyl group, a 2-naphthyl group and a benzyl group.

The group represented by following formula [9] is a further example of the hetero atom-containing group:

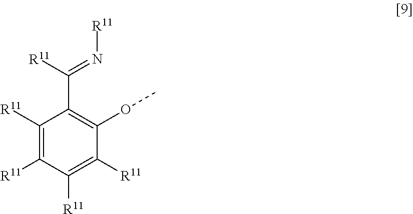

wherein ——— is a bond to M¹; R¹¹ is a hydrogen atom, a halogen atom, a hydrocarbyl group having 1 to 20 carbon atoms, a halogenated hydrocarbyl group having 1 to 20 carbon atoms, a hydrocarbyloxy group having 1 to 20 carbon atoms, a hydrocarbylsilyl group having 1 to 20 carbon atoms, a dihydrocarbylamino group having 2 to 20 carbon atoms, or a group derived from a heterocycle; six R¹¹s are the same as, or different from one another; and any two or more of six R¹¹s may be linked to one another to form a ring.

Examples of the halogen atom of R¹¹ are a fluorine atom, a chlorine atom, a bromine atom, and an iodine atom; examples of the hydrocarbyl group thereof are a phenyl group, a 1-naphthyl group, a 2-naphthyl group, a tert-butyl group, a 2,6-dimethylphenyl group, a 2-fluorenyl group, a 2-methylphenyl group, a 4-methoxyphenyl group, a cyclohexyl group, a 2-isopropylphenyl group, a benzyl group, a methyl group, a 1-methyl-1-phenylethyl group, and a 1,1-dimethylpropyl group; examples of the halogenated hydrocarbyl group thereof are a 4-trifluoromethylphenyl group and a 2-chlorophenyl group; an example of the hydrocarbyloxy group thereof is a methoxy group; examples of the hydrocarbylsilyl group thereof are a triethylsilyl group and a diphenylmethylsilyl group; an example of the dihydrocarbylamino group thereof is a dimethylamino group; and an example of the group derived from a heterocycle thereof is a 4-pyridyl group.

The above chelating ligand means a ligand having two or more coordinating positions, such as acetylacetonate, diimine, oxazoline, bisoxazoline, terpyridine, acylhydrazone, diethylenetriamine, triethylenetetramine, porphyrin, crown ether and cryptate.

As mentioned above, when two or more L²s exist in formula [7], they may be linked to one another directly or through a linking group. For example, (i) two cyclopentadiene-containing anionic groups may be linked to each other through the linking group, (ii) two hetero atom-containing groups may be linked to each other through the linking group, and (iii) a cyclopentadiene-containing anionic group and a hetero atom-containing group may be linked to each other through the linking group. Examples of the linking group are an alkylene group such as an ethylene group and a propylene group; a substituted alkylene group such as a dimethylmethylene group and a diphenylmethylene group; a silylene group; a substituted silylene group such as a dimethylsilylene group, a diphenylsilylene group, a tetramethyldisilylene group; and a hetero atom such as a nitrogen atom, an oxygen atom, a sulfur atom, and a phosphorus atom.

Examples of the halogen atom of X¹ in formula [7] are a fluorine atom, a chlorine atom, a bromine atom and an iodine atom. The hydrocarbyl group and the hydrocarbyloxy group of X¹ in formula [7] may have a substituent. Examples of the substituent are a halogen atom such as a fluorine atom, a chlorine atom, a bromine atom and an iodine atom; and a hydrocarbyloxy group such as an alkoxy group (for example, a methoxy group and an ethoxy group), an aryloxy group (for example, a phenoxy group), and an aralkyloxy group (for example, a benzyloxy group).

Examples of the hydrocarbyl group of X¹ are an alkyl group having 1 to 20 carbon atoms, an aryl group having 6 to 20 carbon atoms, and an aralkyl group having 7 to 20 carbon atoms. Examples of such an alkyl group are a methyl group, an ethyl group, a n-propyl group, an isopropyl group, a n-butyl group, a sec-butyl group, a tert-butyl group, an isobutyl group, a n-pentyl group, a neopentyl group, an amyl group, a n-hexyl group, a n-octyl group, a n-decyl group, a n-dodecyl group, a n-pentadecyl group and a n-eicosyl group. Among them, preferred is a methyl group, an ethyl group, an isopropyl group, a tert-butyl group, an isobutyl group, or an amyl group, more preferred is a methyl group, an ethyl group, or an isobutyl group, and further preferred is a methyl group. An example of such an aryl group is a phenyl group. An example of such an aralkyl group is a benzyl group.

Examples of the hydrocarbyloxy group of X¹ are an alkoxy group having 1 to 20 carbon atoms such as a methoxy group, an ethoxy group, a n-propoxy group, an isopropoxy group, a n-butoxy group, and a tert-butoxy group; an aryloxy group having 6 to 20 carbon atoms such as a phenoxy group; and an aralkyloxy group having 7 to 20 carbon atoms such as a benzyloxy group.

X¹ is preferably a halogen atom, an aralkyl group having 7 to 20 carbon atoms, or an aryloxy group having 6 to 20 carbon atoms, and more preferably a chlorine atom, a benzyl group, or a phenoxy group.

When M¹ in formula [7] is a transition metal atom of group 4, “a” and “b” in formula [7] are preferably 4 and 2, respectively.

Examples of the transition metal compounds represented by formula [7] wherein M¹ is a titanium atom are
bis(cyclopentadienyl)titanium dichloride,
bis(methylcyclopentadienyl)titanium dichloride,
bis(n-butylcyclopentadienyl)titanium dichloride,
bis(dimethylcyclopentadienyl)titanium dichloride,
bis(ethylmethylcyclopentadienyl)titanium dichloride,
bis(trimethylcyclopentadienyl)titanium dichloride,
bis(tetramethylcyclopentadienyl)titanium dichloride,
bis(pentamethylcyclopentadienyl)titanium dichloride,
bis(indenyl)titanium dichloride,
bis(4,5,6,7-tetrahydroindenyl)titanium dichloride,
bis(fluorenyl)titanium dichloride,
bis(2-phenylindenyl)titanium dichloride,
bis[2-(bis-3,5-trifluoromethylphenyl)indenyl]titanium dichloride,
bis[2-(4-tert-butylphenyl)indenyl]titanium dichloride,
bis[2-(4-trifluoromethylphenyl)indenyl]titanium dichloride,
bis[2-(4-methylphenyl)indenyl]titanium dichloride,
bis[2-(3,5-dimethylphenyl)indenyl]titanium dichloride,
bis[2-(pentafluorophenyl)indenyl]titanium dichloride,
cyclopentadienyl(pentamethylcyclopentadienyl)titanium dichloride,
cyclopentadienyl(indenyl)titanium dichloride,
cyclopentadienyl(fluorenyl)titanium dichloride,
indenyl(fluorenyl)titanium dichloride,
pentamethylcyclopentadienyl(indenyl)titanium dichloride,
pentamethylcyclopentadienyl(fluorenyl)titanium dichloride,
cyclopentadienyl(2-phenylindenyl)titanium dichloride,
pentamethylcyclopentadienyl(2-phenylindenyl)titanium dichloride,
ethylenebis(cyclopentadienyl)titanium dichloride,
ethylenebis(2-methylcyclopentadienyl)titanium dichloride,
ethylenebis(3-methylcyclopentadienyl)titanium dichloride,
ethylenebis(2-n-butylcyclopentadienyl)titanium dichloride,
ethylenebis(3-n-butylcyclopentadienyl)titanium dichloride,
ethylenebis(2,3-dimethylcyclopentadienyl)titanium dichloride,
ethylenebis(2,4-dimethylcyclopentadienyl)titanium dichloride,
ethylenebis(2,5-dimethylcyclopentadienyl)titanium dichloride,
ethylenebis(3,4-dimethylcyclopentadienyl)titanium dichloride,
ethylenebis(2,3-ethylmethylcyclopentadienyl)titanium dichloride,
ethylenebis(2,4-ethylmethylcyclopentadienyl)titanium dichloride,
ethylenebis(2,5-ethylmethylcyclopentadienyl)titanium dichloride,
ethylenebis(3,5-ethylmethylcyclopentadienyl)titanium dichloride,
ethylenebis(2,3,4-trimethylcyclopentadienyl)titanium dichloride,
ethylenebis(2,3,5-trimethylcyclopentadienyl)titanium dichloride,
ethylenebis(tetramethylcyclopentadienyl)titanium dichloride,
ethylenebis(indenyl)titanium dichloride,
ethylenebis(4,5,6,7-tetrahydroindenyl)titanium dichloride,
ethylenebis(2-phenylindenyl)titanium dichloride,
ethylenebis(fluorenyl)titanium dichloride,
ethylene(cyclopentadienyl)(pentamethylcyclopentadienyl)titanium dichloride,
ethylene(cyclopentadienyl)(indenyl)titanium dichloride,
ethylene(methylcyclopentadienyl)(indenyl)titanium dichloride,
ethylene(n-butylcyclopentadienyl)(indenyl)titanium dichloride,
ethylene(tetramethylcyclopentadienyl)(indenyl)titanium dichloride,
ethylene(cyclopentadienyl)(fluorenyl)titanium dichloride,
ethylene(methylcyclopentadienyl)(fluorenyl)titanium dichloride,
ethylene(pentamethylcyclopentadienyl)(fluorenyl)titanium dichloride,
ethylene(n-butylcyclopentadienyl)(fluorenyl)titanium dichloride,
ethylene(tetramethylpentadienyl)(fluorenyl)titanium dichloride,
ethylene(indenyl)(fluorenyl)titanium dichloride,
isopropylidenebis(cyclopentadienyl)titanium dichloride,
isopropylidenebis(2-methylcyclopentadienyl)titanium dichloride,
isopropylidenebis(3-methylcyclopentadienyl)titanium dichloride,
isopropylidenebis(2-n-butylcyclopentadienyl)titanium dichloride,
isopropylidenebis(3-n-butylcyclopentadienyl)titanium dichloride,
isopropylidenebis(2,3-dimethylcyclopentadienyl)titanium dichloride,
isopropylidenebis(2,4-dimethylcyclopentadienyl)titanium dichloride,
isopropylidenebis(2,5-dimethylcyclopentadienyl)titanium dichloride,
isopropylidenebis(3,4-dimethylcyclopentadienyl)titanium dichloride,
isopropylidenebis(2,3-ethylmethylcyclopentadienyl)titanium dichloride,
isopropylidenebis(2,4-ethylmethylcyclopentadienyl)titanium dichloride,
isopropylidenebis(2,5-ethylmethylcyclopentadienyl)titanium dichloride,
isopropylidenebis(3,5-ethylmethylcyclopentadienyl)titanium dichloride,
isopropylidenebis(2,3,4-trimethylcyclopentadienyl)titanium dichloride,
isopropylidenebis(2,3,5-trimethylcyclopentadienyl)titanium dichloride,
isopropylidenebis(tetramethylcyclopentadienyl)titanium dichloride,
isopropylidenebis(indenyl)titanium dichloride,
isopropylidenebis(4,5,6,7-tetrahydroindenyl)titanium dichloride,
isopropylidenebis(2-phenylindenyl)titanium dichloride,
isopropylidenebis(fluorenyl)titanium dichloride,
isopropylidene(cyclopentadienyl)(tetramethylcyclopentadienyl)titanium dichloride,
isopropylidene(cyclopentadienyl)(indenyl)titanium dichloride,
isopropylidene(methylcyclopentadienyl)(indenyl)titanium dichloride,
isopropylidene(n-butylcyclopentadienyl)(indenyl)titanium dichloride,
isopropylidene(tetramethylcyclopentadienyl)(indenyl)titanium dichloride,
isopropylidene (cyclopentadienyl)(fluorenyl)titanium dichloride,
isopropylidene(methylcyclopentadienyl)(fluorenyl)titanium dichloride,
isopropylidene(n-butylcyclopentadienyl)(fluorenyl)titanium dichloride,
isopropylidene(tetramethylcyclopentadienyl)(fluorenyl)titanium dichloride,
isopropylidene(indenyl)(fluorenyl)titanium dichloride,
dimethylsilylenebis(cyclopentadienyl)titanium dichloride,
dimethylsilylenebis(2-methylcyclopentadienyl)titanium dichloride,
dimethylsilylenebis(3-methylcyclopentadienyl)titanium dichloride,
dimethylsilylenebis(2-n-butylcyclopentadienyl)titanium dichloride,
dimethylsilylenebis(3-n-butylcyclopentadienyl)titanium dichloride,
dimethylsilylenebis(2,3-dimethylcyclopentadienyl)titanium dichloride,
dimethylsilylenebis(2,4-dimethylcyclopentadienyl)titanium dichloride,
dimethylsilylenebis(2,5-dimethylcyclopentadienyl)titanium dichloride,
dimethylsilylenebis(3,4-dimethylcyclopentadienyl)titanium dichloride,
dimethylsilylenebis(2,3-ethylmethylcyclopentadienyl)titanium dichloride,
dimethylsilylenebis(2,4-ethylmethylcyclopentadienyl)titanium dichloride,
dimethylsilylenebis(2,5-ethylmethylcyclopentadienyl)titanium dichloride,
dimethylsilylenebis(3,5-ethylmethylcyclopentadienyl)titanium dichloride,
dimethylsilylenebis(2,3,4-trimethylcyclopentadienyl)titanium dichloride,
dimethylsilylenebis(2,3,5-trimethylcyclopentadienyl)titanium dichloride,
dimethylsilylenebis(tetramethylcyclopentadienyl)titanium dichloride,
dimethylsilylenebis(indenyl)titanium dichloride,
dimethylsilylenebis(4,5,6,7-tetrahydroindenyl)titanium dichloride,
dimethylsilylene(cyclopentadienyl)(indenyl)titanium dichloride,
dimethylsilylene(methylcyclopentadienyl)(indenyl)titanium dichloride,
dimethylsilylene(n-butylcyclopentadienyl)(indenyl)titanium dichloride,
dimethylsilylene(tetramethylcyclopentadienyl)(indenyl)titanium dichloride,
dimethylsilylene(cyclopentadienyl)(fluorenyl)titanium dichloride,
dimethylsilylene(methylcyclopentadienyl)(fluorenyl)titanium dichloride,
dimethylsilylene(n-butylcyclopentadienyl)(fluorenyl)titanium dichloride,
dimethylsilylene(tetramethylcyclopentadienyl)(fluorenyl)titanium dichloride,
dimethylsilylene(indenyl)(fluorenyl)titanium dichloride;
cyclopentadienyltitanium trichloride,
pentamethylcyclopentadienyltitanium trichloride,
cyclopentadienyl(dimethylamido)titanium dichloride,
cyclopentadienyl(phenoxy)titanium dichloride,
cyclopentadienyl(2,6-dimethylphenyl)titanium dichloride,
cyclopentadienyl(2,6-diisopropylphenyl)titanium dichloride,
cyclopentadienyl(2,6-di-tert-butylphenyl)titanium dichloride,
pentamethylcyclopentadienyl(2,6-dimethylphenyl)titanium dichloride,
pentamethylcyclopentadienyl(2,6-diisopropylphenyl)titanium dichloride,
pentamethylcyclopentadienyl(2,6-di-tert-butylphenyl)titanium dichloride,
indenyl(2,6-diisopropylphenyl)titanium dichloride,
fluorenyl(2,6-diisopropylphenyl)titanium dichloride,
methylene(cyclopentadienyl)(3,5-dimethyl-2-phenoxy)titanium dichloride,
methylene(cyclopentadienyl)(3-tert-butyl-2-phenoxy)titanium dichloride,
methylene(cyclopentadienyl)(3-tert-butyl-5-methyl-2-phenoxy)titanium dichloride,
methylene(cyclopentadienyl)(3-phenyl-2-phenoxy)titanium dichloride,
methylene(cyclopentadienyl)(3-tert-butyldimethylsilyl-5-methyl-2-phenoxy)titanium dichloride,
methylene(cyclopentadienyl)(3-trimethylsilyl-5-methyl-2-phenoxy)titanium dichloride,
methylene(cyclopentadienyl)(3-tert-butyl-5-methoxy-2-phenoxy)titanium dichloride,
methylene(cyclopentadienyl)(3-tert-butyl-5-chloro-2-phenoxy)titanium dichloride,
methylene(methylcyclopentadienyl)(3,5-dimethyl-2-phenoxy) titanium dichloride,
methylene(methylcyclopentadienyl)(3-tert-butyl-2-phenoxy)titanium dichloride,
methylene(methylcyclopentadienyl)(3-tert-butyl-5-methyl-2-phenoxy)titanium dichloride,
methylene(methylcyclopentadienyl)(3-phenyl-2-phenoxy)titanium dichloride,
methylene(methylcyclopentadienyl)(3-tert-butyldimethylsilyl-5-methyl-2-phenoxy)titanium dichloride,
methylene(methylcyclopentadienyl)(3-trimethylsilyl-5-methyl-2-phenoxy)titanium dichloride,
methylene(methylcyclopentadienyl)(3-tert-butyl-5-methoxy-2-phenoxy)titanium dichloride,
methylene(methylcyclopentadienyl)(3-tert-butyl-5-chloro-2-phenoxy)titanium dichloride,
methylene(tert-butylcyclopentadienyl)(3,5-dimethyl-2-phenoxy)titanium dichloride,
methylene(tert-butylcyclopentadienyl)(3-tert-butyl-2-phenoxy)titanium dichloride,
methylene(tert-butylcyclopentadienyl)(3-tert-butyl-5-methyl-2-phenoxy)titanium dichloride,
methylene(tert-butylcyclopentadienyl)(3-phenyl-2-phenoxy)titanium dichloride,
methylene(tert-butylcyclopentadienyl)(3-tert-butyldimethyl silyl-5-methyl-2-phenoxy)titanium dichloride,
methylene(tert-butylcyclopentadienyl)(3-trimethylsilyl-5-methyl-2-phenoxy)titanium dichloride,
methylene(tert-butylcyclopentadienyl)(3-tert-butyl-5-methoxy-2-phenoxy)titanium dichloride,
methylene(tert-butylcyclopentadienyl)(3-tert-butyl-5-chloro-2-phenoxy)titanium dichloride,
methylene(tetramethylcyclopentadienyl)(3,5-dimethyl-2-phenoxy)titanium dichloride,
methylene(tetramethylcyclopentadienyl)(3-tert-butyl-2-phenoxy)titanium dichloride,
methylene(tetramethylcyclopentadienyl)(3-tert-butyl-5-methyl-2-phenoxy)titanium dichloride,
methylene(tetramethylcyclopentadienyl)(3-phenyl-2-phenoxy) titanium dichloride,
methylene(tetramethylcyclopentadienyl)(3-tert-butyldimethyl silyl-5-methyl-2-phenoxy)titanium dichloride,
methylene(tetramethylcyclopentadienyl)(3-trimethylsilyl-5-methyl-2-phenoxy)titanium dichloride,
methylene(tetramethylcyclopentadienyl)(3-tert-butyl-5-methoxy-2-phenoxy)titanium dichloride,
methylene(tetramethylcyclopentadienyl)(3-tert-butyl-5-chloro-2-phenoxy)titanium dichloride,
methylene(trimethylsilylcyclopentadienyl)(3,5-dimethyl-2-phenoxy)titanium dichloride,
methylene(trimethylsilylcyclopentadienyl)(3-tert-butyl-2-phenoxy)titanium dichloride,
methylene(trimethylsilylcyclopentadienyl)(3-tert-butyl-5-methyl-2-phenoxy)titanium dichloride,
methylene(trimethylsilylcyclopentadienyl)(3-phenyl-2-phenoxy)titanium dichloride,
methylene(trimethylsilylcyclopentadienyl)(3-tert-butyl dimethylsilyl-5-methyl-2-phenoxy)titanium dichloride,
methylene(trimethylsilylcyclopentadienyl)(3-trimethylsilyl-5-methyl-2-phenoxy)titanium dichloride,
methylene(trimethylsilylcyclopentadienyl)(3-tert-butyl-5-methoxy-2-phenoxy)titanium dichloride,
methylene(trimethylsilylcyclopentadienyl)(3-tert-butyl-5-chloro-2-phenoxy)titanium dichloride,
methylene(fluorenyl)(3,5-dimethyl-2-phenoxy)titanium dichloride,
methylene(fluorenyl)(3-tert-butyl-2-phenoxy)titanium dichloride,
methylene(fluorenyl)(3-tert-butyl-5-methyl-2-phenoxy)titanium dichloride,
methylene(fluorenyl)(3-phenyl-2-phenoxy)titanium dichloride,
methylene(fluorenyl)(3-tert-butyldimethylsilyl-5-methyl-2-phenoxy)titanium dichloride,
methylene(fluorenyl)(3-trimethylsilyl-5-methyl-2-phenoxy)titanium dichloride,
methylene(fluorenyl)(3-tert-butyl-5-methoxy-2-phenoxy)titanium dichloride,
methylene(fluorenyl)(3-tert-butyl-5-chloro-2-phenoxy)titanium dichloride,
isopropylidene(cyclopentadienyl)(3,5-dimethyl-2-phenoxy)titanium dichloride,
isopropylidene(cyclopentadienyl)(3-tert-butyl-2-phenoxy)titanium dichloride,
isopropylidene(cyclopentadienyl)(3-tert-butyl-5-methyl-2-phenoxy)titanium dichloride,
isopropylidene(cyclopentadienyl)(3-phenyl-2-phenoxy)titanium dichloride,
isopropylidene(cyclopentadienyl)(3-tert-butyldimethylsilyl-5-methyl-2-phenoxy)titanium dichloride,
isopropylidene(cyclopentadienyl)(3-trimethylsilyl-5-methyl-2-phenoxy)titanium dichloride,
isopropylidene(cyclopentadienyl)(3-tert-butyl-5-methoxy-2-phenoxy)titanium dichloride,
isopropylidene(cyclopentadienyl)(3-tert-butyl-5-chloro-2-phenoxy)titanium dichloride,
isopropylidene(methylcyclopentadienyl)(3,5-dimethyl-2-henoxy)titanium dichloride,
isopropylidene(methylcyclopentadienyl)(3-tert-butyl-2-phenoxy)titanium dichloride,
isopropylidene(methylcyclopentadienyl)(3-tert-butyl-5-methyl-2-phenoxy)titanium dichloride,
isopropylidene(methylcyclopentadienyl)(3-phenyl-2-phenoxy)titanium dichloride,
isopropylidene(methylcyclopentadienyl)(3-tert-butyldimethyl silyl-5-methyl-2-phenoxy)titanium dichloride,
isopropylidene(methylcyclopentadienyl)(3-trimethylsilyl-5-methyl-2-phenoxy)titanium dichloride,
isopropylidene(methylcyclopentadienyl)(3-tert-butyl-5-methoxy-2-phenoxy)titanium dichloride,
isopropylidene(methylcyclopentadienyl)(3-tert-butyl-5-chloro-2-phenoxy)titanium dichloride,
isopropylidene(tert-butylcyclopentadienyl)(3,5-dimethyl-2-phenoxy)titanium dichloride,
isopropylidene(tert-butylcyclopentadienyl)(3-tert-butyl-2-phenoxy)titanium dichloride,
isopropylidene(tert-butylcyclopentadienyl)(3-tert-butyl-5-methyl-2-phenoxy)titanium dichloride,
isopropylidene(tert-butylcyclopentadienyl)(3-phenyl-2-phenoxy)titanium dichloride,
isopropylidene(tert-butylcyclopentadienyl)(3-tert-butyl dimethylsilyl-5-methyl-2-phenoxy)titanium dichloride,
isopropylidene(tert-butylcyclopentadienyl)(3-trimethylsilyl-5-methyl-2-phenoxy)titanium dichloride,
isopropylidene(tert-butylcyclopentadienyl)(3-tert-butyl-5-methoxy-2-phenoxy)titanium dichloride,
isopropylidene(tert-butylcyclopentadienyl)(3-tert-butyl-5-chloro-2-phenoxy)titanium dichloride,
isopropylidene(tetramethylcyclopentadienyl)(3,5-dimethyl-2-phenoxy)titanium dichloride,
isopropylidene(tetramethylcyclopentadienyl)(3-tert-butyl-2-phenoxy)titanium dichloride,
isopropylidene(tetramethylcyclopentadienyl)(3-tert-butyl-5-methyl-2-phenoxy)titanium dichloride,
isopropylidene(tetramethylcyclopentadienyl)(3-phenyl-2-phenoxy)titanium dichloride,
isopropylidene(tetramethylcyclopentadienyl)(3-tert-butyl dimethylsilyl-5-methyl-2-phenoxy)titanium dichloride,
isopropylidene(tetramethylcyclopentadienyl)(3-trimethyl silyl-5-methyl-2-phenoxy)titanium dichloride,
isopropylidene(tetramethylcyclopentadienyl)(3-tert-butyl-5-methoxy-2-phenoxy)titanium dichloride,
isopropylidene(tetramethylcyclopentadienyl)(3-tert-butyl-5-chloro-2-phenoxy)titanium dichloride,
isopropylidene(trimethylsilylcyclopentadienyl)(3,5-dimethyl-2-phenoxy)titanium dichloride,
isopropylidene(trimethylsilylcyclopentadienyl)(3-tert-butyl-2-phenoxy)titanium dichloride,
isopropylidene(trimethylsilylcyclopentadienyl)(3-tert-butyl-5-methyl-2-phenoxy)titanium dichloride,
isopropylidene(trimethylsilylcyclopentadienyl)(3-phenyl-2-phenoxy)titanium dichloride,
isopropylidene(trimethylsilylcyclopentadienyl)(3-tert-butyl dimethylsilyl-5-methyl-2-phenoxy)titanium dichloride,
isopropylidene(trimethylsilylcyclopentadienyl)(3-trimethyl silyl-5-methyl-2-phenoxy)titanium dichloride,
isopropylidene(trimethylsilylcyclopentadienyl)(3-tert-butyl-5-methoxy-2-phenoxy)titanium dichloride,
isopropylidene(trimethylsilylcyclopentadienyl)(3-tert-butyl-5-chloro-2-phenoxy)titanium dichloride,
isopropylidene(fluorenyl)(3,5-dimethyl-2-phenoxy)titanium dichloride,
isopropylidene(fluorenyl)(3-tert-butyl-2-phenoxy)titanium dichloride,
isopropylidene(fluorenyl)(3-tert-butyl-5-methyl-2-phenoxy) titanium dichloride,
isopropylidene(fluorenyl)(3-phenyl-2-phenoxy)titanium dichloride,
isopropylidene(fluorenyl)(3-tert-butyldimethylsilyl-5-methyl-2-phenoxy)titanium dichloride,
isopropylidene(fluorenyl)(3-trimethylsilyl-5-methyl-2-phenoxy)titanium dichloride,
isopropylidene(fluorenyl)(3-tert-butyl-5-methoxy-2-phenoxy)titanium dichloride,
isopropylidene(fluorenyl)(3-tert-butyl-5-chloro-2-phenoxy)titanium dichloride,
diphenylmethylene(cyclopentadienyl)(3,5-dimethyl-2-phenoxy)titanium dichloride,
diphenylmethylene(cyclopentadienyl)(3-tert-butyl-2-phenoxy)titanium dichloride,
diphenylmethylene(cyclopentadienyl)(3-tert-butyl-5-methyl-2-phenoxy)titanium dichloride,
diphenylmethylene(cyclopentadienyl)(3-phenyl-2-phenoxy)titanium dichloride,
diphenylmethylene(cyclopentadienyl)(3-tert-butyldimethyl silyl-5-methyl-2-phenoxy)titanium dichloride,
diphenylmethylene(cyclopentadienyl)(3-trimethylsilyl-5-methyl-2-phenoxy)titanium dichloride,
diphenylmethylene(cyclopentadienyl)(3-tert-butyl-5-methoxy-2-phenoxy)titanium dichloride,
diphenylmethylene(cyclopentadienyl)(3-tert-butyl-5-chloro-2-phenoxy)titanium dichloride,
diphenylmethylene(methylcyclopentadienyl)(3,5-dimethyl-2-phenoxy)titanium dichloride,
diphenylmethylene(methylcyclopentadienyl)(3-tert-butyl-2-phenoxy)titanium dichloride,
diphenylmethylene(methylcyclopentadienyl)(3-tert-butyl-5-methyl-2-phenoxy)titanium dichloride,
diphenylmethylene(methylcyclopentadienyl)(3-phenyl-2-phenoxy)titanium dichloride,
diphenylmethylene(methylcyclopentadienyl)(3-tert-butyl dimethylsilyl-5-methyl-2-phenoxy)titanium dichloride,
diphenylmethylene(methylcyclopentadienyl)(3-trimethylsilyl-5-methyl-2-phenoxy)titanium dichloride,
diphenylmethylene(methylcyclopentadienyl)(3-tert-butyl-5-methoxy-2-phenoxy)titanium dichloride,
diphenylmethylene(methylcyclopentadienyl)(3-tert-butyl-5-chloro-2-phenoxy)titanium dichloride,
diphenylmethylene(tert-butylcyclopentadienyl)(3,5-dimethyl-2-phenoxy)titanium dichloride,
diphenylmethylene(tert-butylcyclopentadienyl)(3-tert-butyl-2-phenoxy)titanium dichloride,
diphenylmethylene(tert-butylcyclopentadienyl)(3-tert-butyl-5-methyl-2-phenoxy)titanium dichloride,
diphenylmethylene(tert-butylcyclopentadienyl)(3-phenyl-2-phenoxy)titanium dichloride,
diphenylmethylene(tert-butylcyclopentadienyl)(3-tert-butyl dimethylsilyl-5-methyl-2-phenoxy)titanium dichloride,
diphenylmethylene(tert-butylcyclopentadienyl)(3-trimethyl silyl-5-methyl-2-phenoxy)titanium dichloride,
diphenylmethylene(tert-butylcyclopentadienyl)(3-tert-butyl-5-methoxy-2-phenoxy)titanium dichloride,
diphenylmethylene(tert-butylcyclopentadienyl)(3-tert-butyl-5-chloro-2-phenoxy)titanium dichloride,
diphenylmethylene(tetramethylcyclopentadienyl)(3,5-dimethyl-2-phenoxy)titanium dichloride,
diphenylmethylene(tetramethylcyclopentadienyl)(3-tert-butyl-2-phenoxy)titanium dichloride,
diphenylmethylene(tetramethylcyclopentadienyl)(3-tert-butyl-5-methyl-2-phenoxy)titanium dichloride,
diphenylmethylene(tetramethylcyclopentadienyl)(3-phenyl-2-phenoxy)titanium dichloride,
diphenylmethylene(tetramethylcyclopentadienyl)(3-tert-butyl dimethylsilyl-5-methyl-2-phenoxy)titanium dichloride,
diphenylmethylene(tetramethylcyclopentadienyl)(3-trimethyl silyl-5-methyl-2-phenoxy)titanium dichloride,
diphenylmethylene(tetramethylcyclopentadienyl)(3-tert-butyl-5-methoxy-2-phenoxy)titanium dichloride,
diphenylmethylene(tetramethylcyclopentadienyl)(3-tert-butyl-5-chloro-2-phenoxy)titanium dichloride,
diphenylmethylene(trimethylsilylcyclopentadienyl)(3,5-dimethyl-2-phenoxy)titanium dichloride,
diphenylmethylene(trimethylsilylcyclopentadienyl)(3-tert-butyl-2-phenoxy)titanium dichloride,
diphenylmethylene(trimethylsilylcyclopentadienyl)(3-tert-butyl-5-methyl-2-phenoxy)titanium dichloride,
diphenylmethylene(trimethylsilylcyclopentadienyl)(3-phenyl-2-phenoxy)titanium dichloride,
diphenylmethylene(trimethylsilylcyclopentadienyl)(3-tert-butyldimethylsilyl-5-methyl-2-phenoxy)titanium dichloride,
diphenylmethylene(trimethylsilylcyclopentadienyl)(3-trimethylsilyl-5-methyl-2-phenoxy)titanium dichloride,
diphenylmethylene(trimethylsilylcyclopentadienyl)(3-tert-butyl-5-methoxy-2-phenoxy)titanium dichloride,
diphenylmethylene(trimethylsilylcyclopentadienyl)(3-tert-butyl-5-chloro-2-phenoxy)titanium dichloride,
diphenylmethylene(fluorenyl)(3,5-dimethyl-2-phenoxy)titanium dichloride,
diphenylmethylene(fluorenyl)(3-tert-butyl-2-phenoxy)titanium dichloride,
diphenylmethylene(fluorenyl)(3-tert-butyl-5-methyl-2-phenoxy)titanium dichloride,
diphenylmethylene(fluorenyl)(3-phenyl-2-phenoxy)titanium dichloride,
diphenylmethylene(fluorenyl)(3-tert-butyldimethylsilyl-5-methyl-2-phenoxy)titanium dichloride,
diphenylmethylene(fluorenyl)(3-trimethylsilyl-5-methyl-2-phenoxy)titanium dichloride,
diphenylmethylene(fluorenyl)(3-tert-butyl-5-methoxy-2-phenoxy)titanium dichloride,
diphenylmethylene(fluorenyl)(3-tert-butyl-5-chloro-2-phenoxy)titanium dichloride,
dimethylsilylene(cyclopentadienyl)(2-phenoxy)titanium dichloride,
dimethylsilylene(cyclopentadienyl)(3-methyl-2-phenoxy)titanium dichloride,
dimethylsilylene(cyclopentadienyl)(3,5-dimethyl-2-phenoxy)titanium dichloride,
dimethylsilylene(cyclopentadienyl)(3-tert-butyl-2-phenoxy)titanium dichloride,
dimethylsilylene(cyclopentadienyl)(3-tert-butyl-5-methyl-2-phenoxy)titanium dichloride,
dimethylsilylene(cyclopentadienyl)(3,5-di-tert-butyl-2-phenoxy)titanium dichloride,
dimethylsilylene(cyclopentadienyl)(5-methyl-3-phenyl-2-phenoxy)titanium dichloride,
dimethylsilylene(cyclopentadienyl)(3-tert-butyldimethylsilyl-5-methyl-2-phenoxy)titanium dichloride,
dimethylsilylene(cyclopentadienyl)(5-methyl-3-trimethylsilyl-2-phenoxy)titanium dichloride,
dimethylsilylene(cyclopentadienyl)(3-tert-butyl-5-methoxy-2-phenoxy)titanium dichloride,
dimethylsilylene(cyclopentadienyl)(3-tert-butyl-5-chloro-2-phenoxy)titanium dichloride,
dimethylsilylene(cyclopentadienyl)(3,5-diamyl-2-phenoxy)titanium dichloride,
dimethylsilylene(methylcyclopentadienyl)(2-phenoxy)titanium dichloride,
dimethylsilylene(methylcyclopentadienyl)(3-methyl-2-phenoxy)titanium dichloride,
dimethylsilylene(methylcyclopentadienyl)(3,5-dimethyl-2-phenoxy)titanium dichloride,
dimethylsilylene(methylcyclopentadienyl)(3-tert-butyl-2-phenoxy)titanium dichloride,
dimethylsilylene(methylcyclopentadienyl)(3-tert-butyl-5-methyl-2-phenoxy)titanium dichloride,
dimethylsilylene(methylcyclopentadienyl)(3,5-di-tert-butyl-2-phenoxy)titanium dichloride,
dimethylsilylene(methylcyclopentadienyl)(5-methyl-3-phenyl-2-phenoxy)titanium dichloride,
dimethylsilylene(methylcyclopentadienyl)(3-tert-butyldimethylsilyl-5-methyl-2-phenoxy)titanium dichloride,
dimethylsilylene(methylcyclopentadienyl)(5-methyl-3-trimethylsilyl-2-phenoxy)titanium dichloride,
dimethylsilylene(methylcyclopentadienyl)(3-tert-butyl-5-methoxy-2-phenoxy)titanium dichloride,
dimethylsilylene(methylcyclopentadienyl)(3-tert-butyl-5-chloro-2-phenoxy)titanium dichloride,
dimethylsilylene(methylcyclopentadienyl)(3,5-diamyl-2-phenoxy)titanium dichloride,
dimethylsilylene(n-butylcyclopentadienyl)(2-phenoxy)titanium dichloride,
dimethylsilylene(n-butylcyclopentadienyl)(3-methyl-2-phenoxy)titanium dichloride,
dimethylsilylene(n-butylcyclopentadienyl)(3,5-dimethyl-2-phenoxy)titanium dichloride,
dimethylsilylene(n-butylcyclopentadienyl)(3-tert-butyl-2-phenoxy)titanium dichloride,
dimethylsilylene(n-butylcyclopentadienyl)(3-tert-butyl-5-methyl-2-phenoxy)titanium dichloride,
dimethylsilylene(n-butylcyclopentadienyl)(3,5-di-tert-butyl-2-phenoxy)titanium dichloride,
dimethylsilylene(n-butylcyclopentadienyl)(5-methyl-3-phenyl-2-phenoxy)titanium dichloride,
dimethylsilylene(n-butylcyclopentadienyl)(3-tert-butyl dimethylsilyl-5-methyl-2-phenoxy)titanium dichloride,
dimethylsilylene(n-butylcyclopentadienyl)(5-methyl-3-trimethylsilyl-2-phenoxy)titanium dichloride,
dimethylsilylene(n-butylcyclopentadienyl)(3-tert-butyl-5-methoxy-2-phenoxy)titanium dichloride,
dimethylsilylene(n-butylcyclopentadienyl)(3-tert-butyl-5-chloro-2-phenoxy)titanium dichloride,
dimethylsilylene(n-butylcyclopentadienyl)(3,5-diamyl-2-phenoxy)titanium dichloride,
dimethylsilylene(tert-butylcyclopentadienyl)(2-phenoxy)titanium dichloride,
dimethylsilylene(tert-butylcyclopentadienyl)(3-methyl-2-phenoxy)titanium dichloride,
dimethylsilylene(tert-butylcyclopentadienyl)(3,5-dimethyl-2-phenoxy)titanium dichloride,
dimethylsilylene(tert-butylcyclopentadienyl)(3-tert-butyl-2-phenoxy)titanium dichloride,
dimethylsilylene(tert-butylcyclopentadienyl)(3-tert-butyl-5-methyl-2-phenoxy)titanium dichloride,
dimethylsilylene(tert-butylcyclopentadienyl)(3,5-di-tert-butyl-2-phenoxy)titanium dichloride,
dimethylsilylene(tert-butylcyclopentadienyl)(5-methyl-3-phenyl-2-phenoxy)titanium dichloride,
dimethylsilylene(tert-butylcyclopentadienyl)(3-tert-butyl dimethylsilyl-5-methyl-2-phenoxy)titanium dichloride,
dimethylsilylene(tert-butylcyclopentadienyl)(5-methyl-3-trimethylsilyl-2-phenoxy)titanium dichloride,
dimethylsilylene(tert-butylcyclopentadienyl)(3-tert-butyl-5-methoxy-2-phenoxy)titanium dichloride,
dimethylsilylene(tert-butylcyclopentadienyl)(3-tert-butyl-5-chloro-2-phenoxy)titanium dichloride,
dimethylsilylene(tert-butylcyclopentadienyl)(3,5-diamyl-2-phenoxy)titanium dichloride,
dimethylsilylene(tetramethylcyclopentadienyl)(2-phenoxy)titanium dichloride,
dimethylsilylene(tetramethylcyclopentadienyl)(3-methyl-2-phenoxy)titanium dichloride,
dimethylsilylene(tetramethylcyclopentadienyl)(3,5-dimethyl-2-phenoxy)titanium dichloride,
dimethylsilylene(tetramethylcyclopentadienyl)(3-tert-butyl-2-phenoxy)titanium dichloride,
dimethylsilylene(tetramethylcyclopentadienyl)(3-tert-butyl-5-methyl-2-phenoxy)titanium dichloride,
dimethylsilylene(tetramethylcyclopentadienyl)(3,5-di-tert-butyl-2-phenoxy)titanium dichloride,
dimethylsilylene(tetramethylcyclopentadienyl)(5-methyl-3-phenyl-2-phenoxy)titanium dichloride,
dimethylsilylene(tetramethylcyclopentadienyl)(3-tert-butyl dimethylsilyl-5-methyl-2-phenoxy)titanium dichloride,
dimethylsilylene(tetramethylcyclopentadienyl)(5-methyl-3-trimethylsilyl-2-phenoxy)titanium dichloride,
dimethylsilylene(tetramethylcyclopentadienyl)(3-tert-butyl-5-methoxy-2-phenoxy)titanium dichloride,
dimethylsilylene(tetramethylcyclopentadienyl)(3-tert-butyl-5-chloro-2-phenoxy)titanium dichloride,
dimethylsilylene(tetramethylcyclopentadienyl)(3,5-diamyl-2-phenoxy)titanium dichloride,
dimethylsilylene(trimethylsilylcyclopentadienyl)(2-phenoxy)titanium dichloride,
dimethylsilylene(trimethylsilylcyclopentadienyl)(3-methyl-2-phenoxy)titanium dichloride,
dimethylsilylene(trimethylsilylcyclopentadienyl)(3,5-dimethyl-2-phenoxy)titanium dichloride,
dimethylsilylene(trimethylsilylcyclopentadienyl)(3-tert-butyl-2-phenoxy)titanium dichloride,
dimethylsilylene(trimethylsilylcyclopentadienyl)(3-tert-butyl-5-methyl-2-phenoxy)titanium dichloride,
dimethylsilylene(trimethylsilylcyclopentadienyl)(3,5-di-tert-butyl-2-phenoxy)titanium dichloride,
dimethylsilylene(trimethylsilylcyclopentadienyl)(5-methyl-3-phenyl-2-phenoxy)titanium dichloride,
dimethylsilylene(trimethylsilylcyclopentadienyl)(3-tert-butyldimethylsilyl-5-methyl-2-phenoxy)titanium dichloride,
dimethylsilylene(trimethylsilylcyclopentadienyl)(5-methyl-3-trimethylsilyl-2-phenoxy)titanium dichloride,
dimethylsilylene(trimethylsilylcyclopentadienyl)(3-tert-butyl-5-methoxy-2-phenoxy)titanium dichloride,
dimethylsilylene(trimethylsilylcyclopentadienyl)(3-tert-butyl-5-chloro-2-phenoxy)titanium dichloride,
dimethylsilylene(trimethylsilylcyclopentadienyl)(3,5-diamyl-2-phenoxy)titanium dichloride,
dimethylsilylene(indenyl)(2-phenoxy)titanium dichloride,
dimethylsilylene(indenyl)(3-methyl-2-phenoxy)titanium dichloride,
dimethylsilylene(indenyl)(3,5-dimethyl-2-phenoxy)titanium dichloride,
dimethylsilylene(indenyl)(3-tert-butyl-2-phenoxy)titanium dichloride,
dimethylsilylene(indenyl)(3-tert-butyl-5-methyl-2-phenoxy)titanium dichloride,
dimethylsilylene(indenyl)(3,5-di-tert-butyl-2-phenoxy)titanium dichloride,
dimethylsilylene(indenyl)(5-methyl-3-phenyl-2-phenoxy)titanium dichloride,
dimethylsilylene(indenyl)(3-tert-butyldimethylsilyl-5-methyl-2-phenoxy)titanium dichloride,
dimethylsilylene(indenyl)(5-methyl-3-trimethylsilyl-2-phenoxy)titanium dichloride,
dimethylsilylene(indenyl)(3-tert-butyl-5-methoxy-2-phenoxy)titanium dichloride,
dimethylsilylene(indenyl)(3-tert-butyl-5-chloro-2-phenoxy)titanium dichloride,
dimethylsilylene(indenyl)(3,5-diamyl-2-phenoxy)titanium dichloride,
dimethylsilylene(fluorenyl)(2-phenoxy)titanium dichloride,
dimethylsilylene(fluorenyl)(3-methyl-2-phenoxy)titanium dichloride,
dimethylsilylene(fluorenyl)(3,5-dimethyl-2-phenoxy)titanium dichloride,
dimethylsilylene(fluorenyl)(3-tert-butyl-2-phenoxy)titanium dichloride,
dimethylsilylene(fluorenyl)(3-tert-butyl-5-methyl-2-phenoxy)titanium dichloride,
dimethylsilylene(fluorenyl)(3,5-di-tert-butyl-2-phenoxy)titanium dichloride,
dimethylsilylene(fluorenyl)(5-methyl-3-phenyl-2-phenoxy)titanium dichloride,
dimethylsilylene(fluorenyl)(3-tert-butyldimethylsilyl-5-methyl-2-phenoxy)titanium dichloride,
dimethylsilylene(fluorenyl)(5-methyl-3-trimethylsilyl-2-phenoxy)titanium dichloride,
dimethylsilylene(fluorenyl)(3-tert-butyl-5-methoxy-2-phenoxy)titanium dichloride,
dimethylsilylene(fluorenyl)(3-tert-butyl-5-chloro-2-phenoxy)titanium dichloride,
dimethylsilylene(fluorenyl)(3,5-diamyl-2-phenoxy)titanium dichloride,
(tert-butylamido)tetramethylcyclopentadienyl-1,2-ethanediyl titanium dichloride,
(tert-butylamido)tetramethylcyclopentadienyl-1,2-ethanediyl titanium dimethyl,
(tert-butylamido)tetramethylcyclopentadienyl-1,2-ethanediyl titanium dibenzyl,
(methylamido)tetramethylcyclopentadienyl-1,2-ethanediyl titanium dichloride,
(ethylamido)tetramethylcyclopentadienyl-1,2-ethanediyl titanium dichloride,
(tert-butylamido)tetramethylcyclopentadienyldimethylsilane titanium dichloride,
(tert-butylamido)tetramethylcyclopentadienyldimethylsilane titanium dimethyl,
(tert-butylamido)tetramethylcyclopentadienyldimethylsilane titanium dibenzyl,
(benzylamido)tetramethylcyclopentadienyldimethylsilane titanium dichloride,
(phenylphosphido)tetramethylcyclopentadienyldimethylsilane titanium dibenzyl,
(tert-butylamido)indenyl-1,2-ethanediyltitanium dichloride,
(tert-butylamido)indenyl-1,2-ethanediyltitanium dimethyl,
(tert-butylamido)tetrahydroindenyl-1,2-ethanediyltitanium dichloride,
(tert-butylamido)tetrahydroindenyl-1,2-ethanediyltitanium dimethyl,
(tert-butylamido)fluorenyl-1,2-ethanediyltitanium dichloride,
(tert-butylamido)fluorenyl-1,2-ethanediyltitanium dimethyl,
(tert-butylamido)indenyldimethylsilanetitanium dichloride,
(tert-butylamido)indenyldimethylsilanetitanium dimethyl,
(tert-butylamido)tetrahydroindenyldimethylsilanetitanium dichloride,
(tert-butylamido)tetrahydroindenyldimethylsilanetitanium dimethyl,
(tert-butylamido)fluorenyldimethylsilanetitanium dichloride,
(tert-butylamido)fluorenyldimethylsilanetitanium dimethyl,
(dimethylaminomethyl)tetramethylcyclopentadienyltitanium(III)dichloride,
(dimethylaminoethyl)tetramethylcyclopentadienyltitanium(III)dichloride,
(dimethylaminopropyl)tetramethylcyclopentadienyltitanium(III)dichloride,
(N-pyrrolidinylethyl)tetramethylcyclopentadienyltitanium dichloride,
(B-dimethylaminoborabenzene)cyclopentadienylzirconium dichloride,
cyclopentadienyl(9-mesitylboraanthracenyl)zirconium dichloride,
2,2′-thiobis(4-methyl-6-tert-butylphenoxy)titanium dichloride,
2,2′-thiobis[4-methyl-6-(1-methylethyl)phenoxy]titanium dichloride,
2,2′-thiobis[4,6-dimethylphenoxy]titanium dichloride,
2,2′-thiobis(4-methyl-6-tert-butylphenoxy)titanium dichloride,
2,2′-methylenebis(4-methyl-6-tert-butylphenoxy)titanium dichloride,
2,2′-ethylenebis(4-methyl-6-tert-butylphenoxy)titanium dichloride,
2,2′-sulfinylbis(4-methyl-6-tert-butylphenoxy)titanium dichloride,
2,2′-(4,4′,6,6′-tetra-tert-butyl-1,1′-biphenoxy)titanium dichloride,
2,2′-thiobis(4-methyl-6-tert-butylphenoxy)titanium diisopropoxide,
2,2′-methylenebis(4-methyl-6-tert-butylphenoxy)titanium diisopropoxide,
2,2′-ethylenebis(4-methyl-6-tert-butylphenoxy)titanium diisopropoxide,
2,2′-sulfinylbis(4-methyl-6-tert-butylphenoxy)titanium diisopropoxide,
(di-tert-butyl-1,3-propanediamido)titanium dichloride,
(dicyclohexyl-1,3-propanediamido)titanium dichloride,
[bis(trimethylsilyl)-1,3-propanediamido]titanium dichloride,
[bis(tert-butyldimethylsilyl)-1,3-propanediamido]titanium dichloride,
[bis(2,6-dimethylphenyl)-1,3-propanediamido]titanium dichloride,
[bis(2,6-diisopropylphenyl)-1,3-propanediamido]titanium dichloride,
[bis(2,6-di-tert-butylphenyl)-1,3-propanediamido]titanium dichloride,
[bis(triisopropylsilyl)naphthalenediamido]titanium dichloride,
[bis(trimethylsilyl)naphthalenediamido]titanium dichloride,
[bis(tert-butyldimethylsilyl)naphthalenediamido]titanium dichloride,
[bis(tert-butyldimethylsilyl)naphthalenediamido]titanium dibromide,
[hydrotris(3,5-dimethylpyrazolyl)borate]titanium trichloride,
[hydrotris(3,5-dimethylpyrazolyl)borate]titanium tribromide,
[hydrotris(3,5-dimethylpyrazolyl)borate]titanium triiodide,
[hydrotris(3,5-diethylpyrazolyl)borate]titanium trichloride,
[hydrotris(3,5-diethylpyrazolyl)borate]titanium tribromide,
[hydrotris(3,5-diethylpyrazolyl)borate]titanium triiodide,
[hydrotris(3,5-di-tert-butylpyrazolyl)borate]titanium trichloride,
[hydrotris(3,5-di-tert-butylpyrazolyl)borate]titanium tribromide,
[hydrotris(3,5-di-tert-butylpyrazolyl)borate]titanium triiodide,
[tris(3,5-dimethylpyrazolyl)methyl]titanium trichloride,
[tris(3,5-dimethylpyrazolyl)methyl]titanium tribromide,
[tris(3,5-dimethylpyrazolyl)methyl]titanium triiodide,
[tris(3,5-diethylpyrazolyl)methyl]titanium trichloride,
[tris(3,5-diethylpyrazolyl)methyl]titanium tribromide,
[tris(3,5-diethylpyrazolyl)methyl]titanium triiodide,
[tris(3,5-di-tert-butylpyrazolyl)methyl]titanium trichloride,
[tris(3,5-di-tert-butylpyrazolyl)methyl]titanium tribromide, and
[tris(3,5-di-tert-butylpyrazolyl)methyl]titanium triiodide;
   and compounds formed by changing “titanium” contained in the above compounds to “zirconium” or “hafnium”; compounds formed by changing “(2-phenoxy)” contained in the above compounds to “(3-phenyl-2-phenoxy)”, “(3-trimethylsilyl-2-phenoxy)” or “(3-tert-butyldimethylsilyl-2-phenoxy)”; compounds formed by changing “dimethylsilylene” contained in the above compounds to “diethylsilylene”, “diphenylsilylene” or “dimethoxysilylene”; and compounds formed by changing “dichloride” contained in the above compounds to “difluoride”, “dibromide”, “diiodide”, “dimethoxide”, “diethoxide”, “di-n-butoxide”, “diisopropoxide”, “diphenoxide”, “dimethide”, or “chloridemethide”.

Examples of the transition metal compounds represented by formula [7] wherein M¹ is a nickel atom are
2,2′-methylenebis[(4R)-4-phenyl-5,5′-dimethyloxazoline]nickel dichloride,
2,2′-methylenebis[(4R)-4-phenyl-5,5′-dimethyloxazoline]nickel dibromide,
2,2′-methylenebis[(4R)-4-phenyl-5,5′-diethyloxazoline]nickel dichloride,
2,2′-methylenebis[(4R)-4-phenyl-5,5′-diethyloxazoline]nickel dibromide,
2,2′-methylenebis[(4R)-4-phenyl-5,5′-di-n-propyloxazoline]nickel dichloride,
2,2′-methylenebis[(4R)-4-phenyl-5,5′-di-n-propyloxazoline]nickel dibromide,
2,2′-methylenebis[(4R)-4-phenyl-5,5′-diisopropyloxazoline]nickel dichloride,
2,2′-methylenebis[(4R)-4-phenyl-5,5′-diisopropyloxazoline]nickel dibromide,
2,2′-methylenebis[(4R)-4-phenyl-5,5′-dicyclohexyloxazoline]nickel dichloride,
2,2′-methylenebis[(4R)-4-phenyl-5,5′-dicyclohexyloxazoline]nickel dibromide,
2,2′-methylenebis[(4R)-4-phenyl-5,5′-dimethoxyoxazoline]nickel dichloride,
2,2′-methylenebis[(4R)-4-phenyl-5,5′-dimethoxyoxazoline]nickel dibromide,
2,2′-methylenebis[(4R)-4-phenyl-5,5′-diethoxyoxazoline]nickel dichloride,
2,2′-methylenebis[(4R)-4-phenyl-5,5′-diethoxyoxazoline]nickel dibromide,
2,2′-methylenebis[(4R)-4-phenyl-5,5′-diphenyloxazoline]nickel dichloride,
2,2′-methylenebis[(4R)-4-phenyl-5,5′-diphenyloxazoline]nickel dibromide,
2,2′-methylenebis[(4R)-4-methyl-5,5-di-(2-methylphenyl)oxazoline]nickel dibromide,
2,2′-methylenebis[(4R)-4-methyl-5,5-di-(3-methylphenyl)oxazoline]nickel dibromide,
2,2′-methylenebis[(4R)-4-methyl-5,5-di-(4-methylphenyl)oxazoline]nickel dibromide,
2,2′-methylenebis[(4R)-4-methyl-5,5-di-(2-methoxyphenyl)oxazoline]nickel dibromide,
2,2′-methylenebis[(4R)-4-methyl-5,5-di-(3-methoxyphenyl)oxazoline]nickel dibromide,
2,2′-methylenebis[(4R)-4-methyl-5,5-di-(4-methoxyphenyl)oxazoline]nickel dibromide,
2,2′-methylenebis[spiro{(4R)-4-methyloxazoline-5,1′-cyclobutane}]nickel dibromide,
2,2′-methylenebis[spiro{(4R)-4-methyloxazoline-5,1′-cyclopentane}]nickel dibromide,
2,2′-methylenebis[spiro{(4R)-4-methyloxazoline-5,1′-cyclohexane}]nickel dibromide,
2,2′-methylenebis[spiro{(4R)-4-methyloxazoline-5,1′-cycloheptane}]nickel dibromide,
2,2′-methylenebis[(4R)-4-isopropyl-5,5-dimethyloxazoline]nickel dibromide,
2,2′-methylenebis[(4R)-4-isopropyl-5,5-diethyloxazoline]nickel dibromide,
2,2′-methylenebis[(4R)-4-isopropyl-5,5-di-n-propyloxazoline]nickel dibromide,
2,2′-methylenebis[(4R)-4-isopropyl-5,5-diisopropyloxazoline]nickel dibromide,
2,2′-methylenebis[(4R)-4-isopropyl-5,5-dicyclohexyloxazoline]nickel dibromide,
2,2′-methylenebis[(4R)-4-isopropyl-5,5-diphenyloxazoline]nickel dibromide,
2,2′-methylenebis[(4R)-4-isopropyl-5,5-di-(2-methylphenyl)oxazoline]nickel dibromide,
2,2′-methylenebis[(4R)-4-isopropyl-5,5-di-(3-methylphenyl)oxazoline]nickel dibromide,
2,2′-methylenebis[(4R)-4-isopropyl-5,5-di-(4-methylphenyl)oxazoline]nickel dibromide,
2,2′-methylenebis[(4R)-4-isopropyl-5,5-di-(2-methoxyphenyl)oxazoline]nickel dibromide,
2,2′-methylenebis[(4R)-4-isopropyl-5,5-di-(3-methoxyphenyl)oxazoline]nickel dibromide,
2,2′-methylenebis[(4R)-4-isopropyl-5,5-di-(4-methoxyphenyl)oxazoline]nickel dibromide,
2,2′-methylenebis[spiro{(4R)-4-isopropyloxazoline-5,1′-cyclobutane}]nickel dibromide,
2,2′-methylenebis[spiro{(4R)-4-isopropyloxazoline-5,1′-cyclopentane}]nickel dibromide,
2,2′-methylenebis[spiro{(4R)-4-isopropyloxazoline-5,1′-cyclohexane}]nickel dibromide,
2,2′-methylenebis[spiro{(4R)-4-isopropyloxazoline-5,1′-cycloheptane}]nickel dibromide,
2,2′-methylenebis[(4R)-4-isobutyl-5,5-dimethyloxazoline]nickel dibromide,
2,2′-methylenebis[(4R)-4-isobutyl-5,5-diethyloxazoline]nickel dibromide,
2,2′-methylenebis[(4R)-4-isobutyl-5,5-di-n-propyloxazoline]nickel dibromide,
2,2′-methylenebis[(4R)-4-isobutyl-5,5-diisopropyloxazoline]nickel dibromide,
2,2′-methylenebis[(4R)-4-isobutyl-5,5-dicyclohexyloxazoline]nickel dibromide,
2,2′-methylenebis[(4R)-4-isobutyl-5,5-diphenyloxazoline]nickel dibromide,
2,2′-methylenebis[(4R)-4-isobutyl-5,5-di-(2-methylphenyl)oxazoline]nickel dibromide,
2,2′-methylenebis[(4R)-4-isobutyl-5,5-di-(3-methylphenyl)oxazoline]nickel dibromide,
2,2′-methylenebis[(4R)-4-isobutyl-5,5-di-(4-methylphenyl)oxazoline]nickel dibromide,
2,2′-methylenebis[(4R)-4-isobutyl-5,5-di-(2-methoxyphenyl)oxazoline]nickel dibromide,
2,2′-methylenebis[(4R)-4-isobutyl-5,5-di-(3-methoxyphenyl)oxazoline]nickel dibromide,
2,2′-methylenebis[(4R)-4-isobutyl-5,5-di-(4-methoxyphenyl)oxazoline]nickel dibromide,
2,2′-methylenebis[spiro{(4R)-4-isobutyloxazoline-5,1′-cyclobutane}]nickel dibromide,
2,2′-methylenebis[spiro{(4R)-4-isobutyloxazoline-5,1′-cyclopentane}]nickel dibromide,
2,2′-methylenebis[spiro{(4R)-4-isobutyloxazoline-5,1′-cyclohexane}]nickel dibromide,
2,2′-methylenebis[spiro{(4R)-4-isobutyloxazoline-5,1′-cycloheptane}]nickel dibromide,
2,2′-methylenebis[(4R)-4-tert-butyl-5,5-dimethyloxazoline]nickel dibromide,
2,2′-methylenebis[(4R)-4-tert-butyl-5,5-diethyloxazoline]nickel dibromide,
2,2′-methylenebis[(4R)-4-tert-butyl-5,5-di-n-propyloxazoline]nickel dibromide,
2,2′-methylenebis[(4R)-4-tert-butyl-5,5-diisopropyloxazoline]nickel dibromide,
2,2′-methylenebis[(4R)-4-tert-butyl-5,5-dicyclohexyl oxazoline]nickel dibromide,
2,2′-methylenebis[(4R)-4-tert-butyl-5,5-diphenyloxazoline]nickel dibromide,
2,2′-methylenebis[(4R)-4-tert-butyl-5,5-dicyclohexyl oxazoline]nickel dibromide,
2,2′-methylenebis[(4R)-4-tert-butyl-5,5-diphenyloxazoline]nickel dibromide,
2,2′-methylenebis[(4R)-4-tert-butyl-5,5-di-(2-methylphenyl)oxazoline]nickel dibromide,
2,2′-methylenebis[(4R)-4-tert-butyl-5,5-di-(3-methylphenyl)oxazoline]nickel dibromide,
2,2′-methylenebis[(4R)-4-tert-butyl-5,5-di-(4-methylphenyl)oxazoline]nickel dibromide,
2,2′-methylenebis[(4R)-4-tert-butyl-5,5-di-(2-methoxyphenyl)oxazoline]nickel dibromide,
2,2′-methylenebis[(4R)-4-tert-butyl-5,5-di-(3-methoxyphenyl)oxazoline]nickel dibromide,
2,2′-methylenebis[(4R)-4-tert-butyl-5,5-di-(4-methoxyphenyl)oxazoline]nickel dibromide,
2,2′-methylenebis[spiro{(4R)-4-tert-butyloxazoline-5,1′-cyclobutane}]nickel dibromide,
2,2′-methylenebis[spiro{(4R)-4-tert-butyloxazoline-5,1′-cyclopentane}]nickel dibromide,
2,2′-methylenebis[spiro{(4R)-4-tert-butyloxazoline-5,1′-cyclohexane}]nickel dibromide,
2,2′-methylenebis[spiro{(4R)-4-tert-butyloxazoline-5,1′-cycloheptane}]nickel dibromide,
2,2′-methylenebis[(4R)-4-phenyl-5,5-dimethyloxazoline]nickel dibromide,
2,2′-methylenebis[(4R)-4-phenyl-5,5-diethyloxazoline]nickel dibromide,
2,2′-methylenebis[(4R)-4-phenyl-5,5-di-n-propyloxazoline]nickel dibromide,
2,2′-methylenebis[(4R)-4-phenyl-5,5-diisopropyloxazoline]nickel dibromide,
2,2′-methylenebis[(4R)-4-phenyl-5,5-dicyclohexyl oxazoline]nickel dibromide,
2,2′-methylenebis[(4R)-4-phenyl-5,5-diphenyloxazoline]nickel dibromide,
2,2′-methylenebis[(4R)-4-phenyl-5,5-di-(2-methylphenyl)oxazoline]nickel dibromide,
2,2′-methylenebis[(4R)-4-phenyl-5,5-di-(3-methylphenyl)oxazoline]nickel dibromide,
2,2′-methylenebis[(4R)-4-phenyl-5,5-di-(4-methylphenyl)oxazoline]nickel dibromide,
2,2′-methylenebis[(4R)-4-phenyl-5,5-di-(2-methoxyphenyl)oxazoline]nickel dibromide,
2,2′-methylenebis[(4R)-4-phenyl-5,5-di-(3-methoxyphenyl)oxazoline]nickel dibromide,
2,2′-methylenebis[(4R)-4-phenyl-5,5-di-(4-methoxyphenyl)oxazoline]nickel dibromide,
2,2′-methylenebis[spiro{(4R)-4-phenyloxazoline-5,1′-cyclobutane}]nickel dibromide,
2,2′-methylenebis[spiro{(4R)-4-phenyloxazoline-5,1′-cyclopentane}]nickel dibromide,
2,2′-methylenebis[spiro{(4R)-4-phenyloxazoline-5,1′-cyclohexane}]nickel dibromide,
2,2′-methylenebis[spiro{(4R)-4-phenyloxazoline-5,1′-cycloheptane}]nickel dibromide,
2,2′-methylenebis[(4R)-4-benzyl-5,5-dimethyloxazoline]nickel dibromide,
2,2′-methylenebis[(4R)-4-benzyl-5,5-diethyloxazoline]nickel dibromide,
2,2′-methylenebis[(4R)-4-benzyl-5,5-di-n-propyloxazoline]nickel dibromide,
2,2′-methylenebis[(4R)-4-benzyl-5,5-diisopropyloxazoline]nickel dibromide,
2,2′-methylenebis[(4R)-4-benzyl-5,5-dicyclohexyl oxazoline]nickel dibromide,
2,2′-methylenebis[(4R)-4-benzyl-5,5-diphenyloxazoline]nickel dibromide,
2,2′-methylenebis[(4R)-4-benzyl-5,5-di-(2-methylphenyl)oxazoline]nickel dibromide,
2,2′-methylenebis[(4R)-4-benzyl-5,5-di-(3-methylphenyl)oxazoline]nickel dibromide,
2,2′-methylenebis[(4R)-4-benzyl-5,5-di-(4-methylphenyl)oxazoline]nickel dibromide,
2,2′-methylenebis[(4R)-4-benzyl-5,5-di-(2-methoxyphenyl)oxazoline]nickel dibromide,
2,2′-methylenebis[(4R)-4-benzyl-5,5-di-(3-methoxyphenyl)oxazoline]nickel dibromide,
2,2′-methylenebis[(4R)-4-benzyl-5,5-di-(4-methoxyphenyl)oxazoline]nickel dibromide,
2,2′-methylenebis[spiro{(4R)-4-benzyloxazoline-5,1′-cyclobutane}]nickel dibromide,
2,2′-methylenebis[spiro{(4R)-4-benzyloxazoline-5,1′-cyclopentane}]nickel dibromide,
2,2′-methylenebis[spiro{(4R)-4-benzyloxazoline-5,1′-cyclohexane}]nickel dibromide, and
2,2′-methylenebis[spiro{(4R)-4-benzyloxazoline-5,1′-cycloheptane}]nickel dibromide;
   and antipodes of the above respective compounds; compounds formed by reversing a steric configuration of an asymmetric carbon on one oxazoline ring contained in the above bisoxazoline compounds; and compounds formed by changing “dibromide” contained in the above compounds to “dichloride”, “dimethoxide” or “dimethide”.

Further examples of the nickel compound are
[hydrotris(3,5-dimethylpyrazolyl)borate]nickel chloride,
[hydrotris(3,5-dimethylpyrazolyl)borate]nickel bromide,
[hydrotris(3,5-dimethylpyrazolyl)borate]nickel iodide,
[hydrotris(3,5-diethylpyrazolyl)borate]nickel chloride,
[hydrotris(3,5-diethylpyrazolyl)borate]nickel bromide,
[hydrotris(3,5-diethylpyrazolyl)borate]nickel iodide,
[hydrotris(3,5-di-tert-butylpyrazolyl)borate]nickel chloride,
[hydrotris(3,5-di-tert-butylpyrazolyl)borate]nickel bromide, and
[hydrotris(3,5-di-tert-butylpyrazolyl)borate]nickel iodide;
   and nickel compounds represented by following formula [10]:

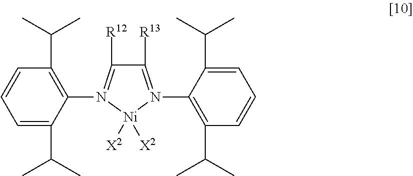

wherein R¹² and R¹³ are a hydrogen atom, a methyl group or a naphthalene-1,8-dily group, and X² is a fluorine atom, a chlorine atom, an iodine atom, a methyl group, an ethyl group, a n-propyl group, an isopropyl group, a n-butyl group, a phenyl group, or a benzyl group.

Above R¹², R¹³ and X² have the following combinations (1) to (3), wherein each of combinations (1) to (3) has further ten combinations, therefore their total combination number is 30:

(1) when R¹² and R¹³ are a hydrogen atom, X² is a fluorine atom, a chlorine atom, an iodine atom, a methyl group, an ethyl group, a n-propyl group, an isopropyl group, a n-butyl group, a phenyl group, or a benzyl group;

(2) when R¹² and R¹³ are a methyl group, X² is a fluorine atom, a chlorine atom, an iodine atom, a methyl group, an ethyl group, a n-propyl group, an isopropyl group, a n-butyl group, a phenyl group, or a benzyl group; and

(3) when R¹² and R¹³ are a naphthalene-1,8-dily group, X² is a fluorine atom, a chlorine atom, an iodine atom, a methyl group, an ethyl group, a n-propyl group, an isopropyl group, a n-butyl group, a phenyl group, or a benzyl group.

Still further examples of the transition metal compound in the present invention are compounds formed by changing “nickel” contained in the above nickel compounds to “palladium”, “cobalt”, “rhodium” or “ruthenium”.

Examples of the transition metal compounds represented by formula [7] wherein M¹ is an iron atom are
2,6-bis-[1-(2,6-dimethylphenylimino)ethyl]pyridineiron dichloride,
2,6-bis-[1-(2,6-diisopropylphenylimino)ethyl]pyridineiron dichloride,
2,6-bis-[1-(2-tert-butyl-phenylimino)ethyl]pyridineiron dichloride,
[hydrotris(3,5-dimethylpyrazolyl)borate]iron chloride,
[hydrotris(3,5-dimethylpyrazolyl)borate]iron bromide,
[hydrotris(3,5-dimethylpyrazolyl)borate]iron iodide,
[hydrotris(3,5-diethylpyrazolyl)borate]iron chloride,
[hydrotris(3,5-diethylpyrazolyl)borate]iron bromide,
[hydrotris(3,5-diethylpyrazolyl)borate]iron iodide,
[hydrotris(3,5-di-tert-butylpyrazolyl)borate]iron chloride,
[hydrotris(3,5-di-tert-butylpyrazolyl)borate]iron bromide,
[hydrotris(3,5-di-tert-butylpyrazolyl)borate]iron iodide;
   and compounds formed by changing “iron” contained in the above compounds to “cobalt” or “nickel”.

Examples of the μ-oxo type transition metal compound of the transition metal compound represented by formula [7] are
μ-oxobis[isopropylidene(cyclopentadienyl)(2-phenoxy)titanium hloride],
μ-oxobis[isopropylidene(cyclopentadienyl)(2-phenoxy)titanium methoxide],
μ-oxobis[isopropylidene(cyclopentadienyl)(3-tert-butyl-5-methyl-2-phenoxy)titanium chloride],
μ-oxobis[isopropylidene(cyclopentadienyl)(3-tert-butyl-5-methyl-2-phenoxy)titanium methoxide],
μ-oxobis[isopropylidene(methylcyclopentadienyl)(2-phenoxy)titanium chloride],
μ-oxobis[isopropylidene(methylcyclopentadienyl)(2-phenoxy)titanium methoxide],
μ-oxobis[isopropylidene(methylcyclopentadienyl)(3-tert-butyl-5-methyl-2-phenoxy)titanium chloride],
μ-oxobis[isopropylidene(methylcyclopentadienyl)(3-tert-butyl-5-methyl-2-phenoxy)titanium methoxide],
μ-oxobis[isopropylidene(tetramethylcyclopentadienyl)(2-phenoxy)titanium chloride],
μ-oxobis[isopropylidene(tetramethylcyclopentadienyl)(2-phenoxy)titanium methoxide],
μ-oxobis[isopropylidene(tetramethylcyclopentadienyl)(3-tert-butyl-5-methyl-2-phenoxy)titanium chloride],
μ-oxobis[isopropylidene(tetramethylcyclopentadienyl)(3-tert-butyl-5-methyl-2-phenoxy)titanium methoxide],
μ-oxobis[dimethylsilylene(cyclopentadienyl)(2-phenoxy)titanium chloride],
μ-oxobis[dimethylsilylene(cyclopentadienyl)(2-phenoxy)titanium methoxide],
μ-oxobis[dimethylsilylene(cyclopentadienyl)(3-tert-butyl-5-methyl-2-phenoxy)titanium chloride],
μ-oxobis[dimethylsilylene(cyclopentadienyl)(3-tert-butyl-5-methyl-2-phenoxy)titanium methoxide],
μ-oxobis[dimethylsilylene(methylcyclopentadienyl)(2-henoxy)titanium chloride],
μ-oxobis[dimethylsilylene(methylcyclopentadienyl)(2-henoxy)titanium methoxide],
μ-oxobis[dimethylsilylene(methylcyclopentadienyl)(3-tert-butyl-5-methyl-2-phenoxy)titanium chloride],
μ-oxobis[dimethylsilylene(methylcyclopentadienyl)(3-tert-butyl-5-methyl-2-phenoxy)titanium methoxide],
μ-oxobis[dimethylsilylene(tetramethylcyclopentadienyl)(2-phenoxy)titanium chloride],
μ-oxobis[dimethylsilylene(tetramethylcyclopentadienyl)(2-phenoxy)titanium methoxide],
μ-oxobis[dimethylsilylene(tetramethylcyclopentadienyl)(3-tert-butyl-5-methyl-2-phenoxy)titanium chloride],
μ-oxobis[dimethylsilylene(tetramethylcyclopentadienyl)(3-tert-butyl-5-methyl-2-phenoxy)titanium methoxide],
di-μ-oxobis[isopropylidene(cyclopentadienyl)(2-phenoxy)titanium],
di-μ-oxobis[isopropylidene(cyclopentadienyl)(3-tert-butyl-5-methyl-2-phenoxy)titanium],
di-μ-oxobis[isopropylidene(methylcyclopentadienyl)(2-phenoxy)titanium],
di-μ-oxobis[isopropylidene(methylcyclopentadienyl)(3-tert-butyl-5-methyl-2-phenoxy)titanium],
di-μ-oxobis[isopropylidene(tetramethylcyclopentadienyl)(2-phenoxy)titanium],
di-μ-oxobis[isopropylidene(tetramethylcyclopentadienyl)(3-tert-butyl-5-methyl-2-phenoxy)titanium],
di-μ-oxobis[dimethylsilylene(cyclopentadienyl)(2-phenoxy)titanium],
di-μ-oxobis[dimethylsilylene(cyclopentadienyl)(3-tert-butyl-5-methyl-2-phenoxy)titanium],
di-μ-oxobis[dimethylsilylene(methylcyclopentadienyl)(2-phenoxy)titanium],
di-μ-oxobis[dimethylsilylene(methylcyclopentadienyl)(3-tert-butyl-5-methyl-2-phenoxy)titanium],
di-μ-oxobis[dimethylsilylene(tetramethylcyclopentadienyl)(2-phenoxy)titanium], and
di-μ-oxobis[dimethylsilylene(tetramethylcyclopentadienyl)(3-tert-butyl-5-methyl-2-phenoxy)titanium].

The above transition metal compounds may be used in combination of two or more thereof. The transition metal compound in the present invention is preferably a transition metal compound represented by formula [7]; more preferably a transition metal compound represented thereby wherein M¹ is a transition metal atom of group 4; and further preferably a transition metal compound represented thereby wherein (i) M¹ is a transition metal atom of group 4, and (ii) one or more L²s are a cyclopentadiene-containing anionic group.

Among the above further preferable transition metal compounds, preferred is a transition metal compound represented by following formula [11], and more preferred is a transition metal compound represented by following formula [12]:

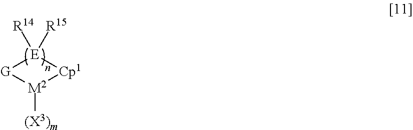

wherein M² is a transition metal atom of group 4 of the periodic table of elements; Cp¹ is a cyclopentadiene-containing anionic group having 5 to 30 carbon atoms; R¹⁴ and R¹⁵ are a hydrogen atom or a hydrocarbyl group having 1 to 20 carbon atoms, and they are different from each other; E is an atom of group 14 of the periodic table of elements; X³ is a halogen atom, a hydrocarbyl group having 1 to 20 carbon atoms, or a hydrocarbyloxy group having 1 to 20 carbon atoms; G is a cyclopentadiene-containing anionic group having 5 to 30 carbon atoms, or a group represented by following formula [13]; n is an integer of 1 to 6; m is 1 or 2; when n is 2 or more, plural Es are the same as, or different from one another, plural R¹⁴s are the same as, or different from one another, and plural R¹⁵s are the same as, or different from one another; and when m is 2, two X³s are the same as, or different from each other;

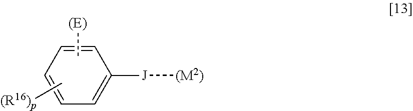

wherein J is an atom of group 16 of the periodic table of elements; R¹⁶ is a hydrocarbyl group having 1 to 20 carbon atoms; ————(M²) is a bond to M² in formula [11]; ————(E) is a bond to E in formula [11]; and p is an integer of 0 to 4, and when p is 2 or more, plural R¹⁶s are the same as, or different from one another;

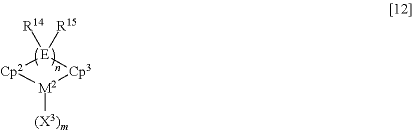

wherein M² is a transition metal atom of group 4 of the periodic table of elements; Cp² and Cp³ are a cyclopentadiene-containing anionic group having 5 to 30 carbon atoms, and they are different from each other; R¹⁴ and R¹⁵ are a hydrogen atom or a hydrocarbyl group having 1 to 20 carbon atoms, and they are different from each other; E is an atom of group 14 of the periodic table of elements; X³ is a halogen atom, a hydrocarbyl group having 1 to 20 carbon atoms, or a hydrocarbyloxy group having 1 to 20 carbon atoms; n is an integer of 1 to 6; m is 1 or 2; when n is 2 or more, plural Es are the same as, or different from one another, plural R¹⁴s are the same as, or different from one another, and plural R¹⁵s are the same as, or different from one another; and when m is 2, two X¹s are the same as, or different from each other.

Examples of M² in formulas [11] and [12] are a titanium atom, a zirconium atom and a hafnium atom. Among them, preferred is a zirconium atom. Examples of E are a carbon atom and a silicon atom. Examples of the cyclopentadiene-containing anionic group of G, Cp¹, Cp² and Cp³ are the same as those above-exemplified as L² in formula [7]. Examples of the halogen atom, the hydrocarbyl group and the hydrocarbyloxy group of X³ are the same as those above-exemplified as X′ in formula [7], respectively. Examples of the hydrocarbyl group of R¹⁴ and R¹⁵ are the same as those above-exemplified as L¹ in formula [1].

Examples of J in formula [13] are an oxygen atom and a sulfur atom. Among them, preferred is an oxygen atom. Examples of the hydrocarbyl group of R¹⁶ are the same as those above-exemplified as L¹ in formula [1].

An organoaluminum compound in the present invention is preferably an organoaluminum compound represented by following formula [14]:

(R¹⁷)_{d}Al(X⁴)_{3-d} [14]

wherein R¹⁷ is a hydrocarbyl group having 1 to 24 carbon atoms; X⁴ is a hydrogen atom, a halogen atom, or a hydrocarbyloxy group having 1 to 24 carbon atoms; and d is an integer of 1 to 3, and when d is 2 or 3, plural R¹⁷s are the same as, or different from one another, and when d is 1, two X⁴s are the same as, or different from each other.

R¹⁷ is preferably an alkyl group, such as a methyl group, an ethyl group, a n-propyl group, a n-butyl group, an isobutyl group, a n-hexyl group, a 2-methylhexyl group, and a n-octyl group. Among them, preferred is an ethyl group, a n-butyl group, an isobutyl group, a n-hexyl group, or a n-octyl group.

Examples of the halogen atom of X⁴ are a fluorine atom, a chlorine atom, a bromine atom, and an iodine atom. Among them, preferred is a chlorine atom.

Examples of the hydrocarbyloxy group of X⁴ are an alkoxy group having 1 to 24 carbon atoms, an aryloxy group having 6 to 24 carbon atoms, and an aralkyloxy group having 7 to 24 carbon atoms.

Examples of the alkoxy group of X⁴ are a methoxy group, an ethoxy group, a n-propoxy group, an isopropoxy group, a n-butoxy group, a sec-butoxy group, a tert-butoxy group, a n-pentoxy group, and a n-eicosoxy group. Among them, preferred is a methoxy group, an ethoxy group or a tert-butoxy group.

Examples of the aryloxy group of X⁴ are a phenoxy group, a 2-methylphenoxy group, a 3-methylphenoxy group, a 4-methylphenoxy group, a 2,3-dimethylphenoxy group, a 2,4-dimethylphenoxy group, a 2,5-dimethylphenoxy group, a 2,6-dimethylphenoxy group, a 3,4-dimethylphenoxy group, a 3,5-dimethylphenoxy group, a 2,3,4-trimethylphenoxy group, a 2,3,5-trimethylphenoxy group, a 2,3,6-trimethylphenoxy group, a 2,4,5-trimethylphenoxy group, a 2,4,6-trimethylphenoxy group, a 3,4,5-trimethylphenoxy group, a 2,3,4,5-tetramethylphenoxy group, a 2,3,4,6-tetramethylphenoxy group, 2,3,5,6-tetramethylphenoxy group, a pentamethylphenoxy group, an ethylphenoxy group, a n-propylphenoxy group, an isopropylphenoxy group, a n-butylphenoxy group, a sec-butylphenoxy group, a tert-butylphenoxy group, a n-hexylphenoxy group, a n-octylphenoxy group, a n-decylphenoxy group, a n-tetradecylphenoxy group, a naphthoxy group, and an anthrathenoxy group.

Examples of the aralkyloxy group of X⁴ are a benzyloxy group, a (2-methylphenyl)methoxy group, a (3-methylphenyl)methoxy group, a (4-methylphenyl)methoxy group, a (2,3-dimethylphenyl)methoxy group, a (2,4-dimethylphenyl)methoxy group, a (2,5-dimethylphenyl)methoxy group, a (2,6-dimethylphenyl)methoxy group, a (3,4-dimethylphenyl)methoxy group, a (3,5-dimethylphenyl)methoxy group, a (2,3,4-trimethylphenyl)methoxy group, a (2,3,5-trimethylphenyl)methoxy group, a (2,3,6-trimethylphenyl)methoxy group, a (2,4,5-trimethylphenyl)methoxy group, a (2,4,6-trimethylphenyl)methoxy group, a (3,4,5-trimethylphenyl)methoxy group, a (2,3,4,5-tetramethylphenyl)methoxy group, a (2,3,5,6-tetramethylphenyl)methoxy group, a (pentamethylphenyl)methoxy group, an (ethylphenyl)methoxy group, a (n-propylphenyl)methoxy group, an (isopropylphenyl)methoxy group, a (n-butylphenyl)methoxy group, a (sec-butylphenyl)methoxy group, a (tert-butylphenyl)methoxy group, a (n-hexylphenyl)methoxy group, a (n-octylphenyl)methoxy group, a (n-decylphenyl)methoxy group, a (n-tetradecylphenyl)methoxy group, a naphthylmethoxy group, and an anthrathenylmethoxy group. Among them, preferred is a benzyloxy group.

Examples of the organoaluminum compound represented by formula [14] are a trialkylaluminum such as trimethylaluminum, triethylaluminum, tri-n-propylaluminum, tri-n-butylaluminum, triisobutylaluminum, tri-n-hexylaluminum, and tri-n-octylaluminum; a dialkylaluminum chloride such as dimethylaluminum chloride, diethylaluminum chloride, di-n-propylaluminum chloride, di-n-butylaluminum chloride, diisobutylaluminum chloride, and di-n-hexylaluminum chloride; an alkylaluminum dichloride such as methylaluminum dichloride, ethylaluminum dichloride, n-propylaluminum dichloride, n-butylaluminum dichloride, isobutylaluminum dichloride, and n-hexylaluminum dichloride; a dialkylaluminum hydride such as dimethylaluminum hydride, diethylaluminum hydride, di-n-propylaluminum hydride, di-n-butylaluminum hydride, diisobutylaluminum hydride, and di-n-hexylaluminum hydride; an alkyl(dialkoxy)aluminum such as methyl(dimethoxy)aluminum, methyl(diethoxy)aluminum, and methyl(di-tert-butoxy)aluminum; a dialkyl(alkoxy)aluminum such as dimethyl(methoxy)aluminum, dimethyl(ethoxy)aluminum, and dimethyl(tert-butoxy)aluminum; an alkyl(diaryloxy)aluminum such as methyl(diphenoxy)aluminum, methylbis(2,6-diisopropylphenoxy)aluminum, and methylbis(2,6-diphenylphenoxy)aluminum; and a dialkyl(aryloxy)aluminum such as dimethyl(phenoxy)aluminum, dimethyl(2,6-diisopropylphenoxy)aluminum, and dimethyl(2,6-diphenylphenoxy)aluminum; and a combination of two or more thereof. Among them, preferred is a trialkylaluminum, more preferred is trimethylaluminum, triethylaluminum, tri-n-butylaluminum, triisobutylaluminum, or tri-n-hexylaluminum, and further preferred is triisobutylaluminum or tri-n-octylaluminum.

In the catalyst production process of the present invention, the zinc atom-containing compound is used in an amount of usually 1 to 1,000,000 mol, preferably 10 to 500,000 mol, and more preferably 100 to 100,000 mol, in terms of a molar amount of a zinc atom contained in the zinc atom-containing compound used, per 1 mol of the transition metal compound used. The organoaluminum compound is used in an amount of preferably 0.01 to 10,000,000 mol, more preferably 0.1 to 1,000,000 mol, further preferably 1 to 100,000 mol, and particularly preferably 10 to 10,000 mol, in terms of a molar amount of an aluminum atom contained in the organoaluminum compound used, per 1 mol of a transition metal atom contained in the transition metal compound used.

Examples of a specific method of the catalyst production process of the present invention are following methods (I) to (III):

(I) a method comprising steps of preparing a catalyst in a catalyst-preparing reactor, and then feeding the catalyst to a polymerization reactor;

(II) a method comprising a step of preparing a catalyst in a polymerization reactor; and

(III) a method comprising steps of contacting any two of the zinc atom-containing compound, the transition metal compound and the organoaluminum compound in a catalyst-preparing reactor, thereby forming a contact product, and then feeding the contact product and the remaining compound to a polymerization reactor, thereby preparing a catalyst.

More specific examples of above method (I) are following methods (1) to (4), and preferred is method (4), wherein “component (A)”, “component (B)” and “component (C)” mean the zinc atom-containing compound, the transition metal compound and the organoaluminum compound, respectively:

(1) a method comprising a step of feeding components (A), (B) and (C) simultaneously to a catalyst-preparing reactor to contact them with one another, thereby preparing a catalyst;

(2) a method comprising steps of feeding components (A) and (B) to a catalyst-preparing reactor, thereby forming a contact product, and then contacting the contact product with component (C), thereby preparing a catalyst;

(3) a method comprising steps of feeding components (A) and (C) to a catalyst-preparing reactor, thereby forming a contact product, and then contacting the contact product with component (B), thereby preparing a catalyst; and

(4) a method comprising steps of feeding components (B) and (C) to a catalyst-preparing reactor, thereby forming a contact product, and then contacting the contact product with component (A), thereby preparing a catalyst.

More specific examples of above method (II) are following methods (1) to (4), and preferred is method (4):

(1) a method comprising a step of feeding components (A), (B) and (C) simultaneously to a polymerization reactor, in the presence of a monomer, to contact them with one another, thereby preparing a catalyst;

(2) a method comprising steps of feeding components (A) and (B) to a polymerization reactor in the presence of a monomer, thereby forming a contact product, and then contacting the contact product with component (C), thereby preparing a catalyst;

(3) a method comprising steps of feeding components (A) and (C) to a polymerization reactor in the presence of a monomer, thereby forming a contact product, and then contacting the contact product with component (B), thereby preparing a catalyst; and

(4) a method comprising steps of feeding components (B) and (C) to a polymerization reactor in the presence of a monomer, thereby forming a contact product, and then contacting the contact product with component (A), thereby preparing a catalyst.

More specific examples of above method (III) are following methods (1) to (3), and preferred is method (3):

(1) a method comprising steps of feeding components (A) and (B) to a catalyst-preparing reactor to contact them with each other, thereby forming a contact product, and then feeding the contact product and component (C) to a polymerization reactor to contact them with each other in the presence of a monomer, thereby preparing a catalyst;

(2) a method comprising steps of feeding components (A) and (C) to a catalyst-preparing reactor to contact them with each other, thereby forming a contact product, and then feeding the contact product and component (B) to a polymerization reactor to contact them with each other in the presence of a monomer, thereby preparing a catalyst; and

(3) a method comprising steps of feeding components (B) and (C) to a catalyst-preparing reactor to contact them with each other, thereby forming a contact product, and then feeding the contact product and component (A) to a polymerization reactor to contact them with each other in the presence of a monomer, thereby preparing a catalyst.

Components (A), (B) or (C) is fed to a catalyst-preparing reactor or a polymerization reactor (i) in its solid state, or (ii) in its combination with a hydrocarbon solvent, such as a solution, suspension and slurry, the hydrocarbon solvent being sufficiently free from materials such as water and oxygen, which deactivate component (A), (B) or (C).

When combining component (A), (B) or (C) with a hydrocarbon solvent, a concentration of component (A) in the combination is usually 0.001 to 100 mol/liter, and preferably 0.01 to 10 mol/liter, in terms of a molar amount of a zinc atom contained in component (A) used; a concentration of component (B) in the combination is usually 0.00001 to 1 mol/liter, and preferably 0.0001 to 0.1 mol/liter; and a concentration of component (C) in the combination is usually 0.0001 to 100 mol/liter, and preferably 0.01 to 10 mol/liter, in terms of a molar amount of an aluminum atom contained in component (C) used.

Examples of a polymerization method in the polymer production process of the present invention are (1) a gas phase polymerization method polymerizing a gaseous monomer, (2) a solution polymerization method polymerizing a monomer dissolved in a solvent, (3) a slurry polymerization method polymerizing a monomer suspended in a solvent, and (4) a bulk polymerization method polymerizing a liquid monomer as a solvent. Examples of the above solvent are an aliphatic hydrocarbon solvent such as butane, pentane, hexane, heptane and octane; an aromatic hydrocarbon solvent such as benzene and toluene; and a halogenated hydrocarbon solvent such as methylene chloride. The polymerization in the present invention is carried out usually for 1 minute to 20 hours, depending on a type of a target olefin polymer and a polymerization reactor, in a continuous manner, a batch-wise manner, or a combined manner thereof, and may be carried out in two or more steps having different polymerization conditions from one another. In the polymer production process of the present invention, its polymerization step is preferably carried out in the absence of hydrogen gas.

The above slurry polymerization method may be carried out by a slurry polymerization method known in the art, under a slurry polymerization condition known in the art. A preferable embodiment of the slurry polymerization method uses a continuous reactor, wherein necessary starting materials such a monomer, a comonomer, a diluent and other materials are added, if necessary continuously, to the continuous reactor, and a produced polymer is taken out continuously or periodically from the continuous reactor. Examples of the continuous reactor are a loop reactor, and a reactor combining stirrer-equipped plural reactors in series or in parallel, wherein the plural reactors are different from one another in their structure and polymerization reaction condition. An example of the above diluent is an inert diluent (medium) such as paraffin, cycloparaffin and an aromatic hydrocarbon.

A polymerization reactor or its reaction zone used in a slurry polymerization method has polymerization temperature of usually 0 to about 150° C., and preferably 30 to 100° C., and has polymerization pressure of 0.1 to about 10 MPa, and preferably 0.5 to 5 MPa. There can be applied polymerization pressure such that a polymerization catalyst is maintained in its suspension state, and a medium and at least part of a monomer or comonomer are maintained in their liquid state. Namely, a medium, polymerization temperature and polymerization pressure may be selected such that a particulate olefin polymer is produced, and the produced particulate olefin polymer is recovered in its particulate shape.

In a slurry polymerization method, respective polymerization components, a monomer and a comonomer can be supplied to a polymerization reactor or a reaction zone, in any order, by any method known in the art. For example, those polymerization components, monomer and comonomer are supplied to a reaction zone, at one time, or successively. If desired, those polymerization components, monomer and comonomer are contacted previously with one another in an inert atmosphere to form a contacted product, and then the contact product is sullied to a reaction zone.

An olefin polymer produced by a slurry polymerization method can be controlled in its molecular weight by a method known in the art, such as a temperature regulation of a reaction zone, and an introduction of hydrogen into the reaction zone.

The above gas phase polymerization method may be carried out by a gas phase polymerization method known in the art, under a gas phase polymerization condition known in the art, but is not limited thereto. An example of a gas phase polymerization reactor is a fluidized bed reactor, and preferably a fluidized bed reactor having an enlarged part. The reactor may have an internal stirrer.

Examples of a method for supplying respective components to a gas phase polymerization reactor are (1) a method of supplying them in the absence of water by using an inert gas (for example, nitrogen and argon), hydrogen or ethylene, and (2) a method of supplying them in a solution or slurry state dissolved in or diluted with a solvent. Respective components may be supplied to a gas phase polymerization reactor individually, or may be supplied after mutually pre-contacting them in any order.

Gas phase polymerization is carried out at preferably 0° to 300° C., further preferably 10 to 200° C., and particularly preferably 30 to 100° C. In order to control a melt-flowability of a produced olefin polymer, a molecular weight regulator such as hydrogen may be used, and an inert gas may be coexisted in a polymerization system.

The above olefin polymerization catalyst produced by the catalyst production process of the present invention is used directly (namely, without modification) for olefin polymerization, which polymerization is usually referred to as “main polymerization” in the art; or is modified by the following method to produce a pre-polymerized catalyst, which is used for main polymerization. The pre-polymerized catalyst can be obtained by polymerizing a small amount of an olefin in the presence of the olefin polymerization catalyst produced by the catalyst production process of the present invention, under pre-polymerization conditions known in the art, and such polymerization of a small amount of an olefin is referred to as “pre-polymerization” in contrast to the above main polymerization.

Examples of an olefin used in the polymer production process of the present invention are ethylene; an α-olefin having 3 to 20 carbon atoms such as propylene, 1-butene, 1-pentene, 4-methyl-1-pentene, 5-methyl-1-hexene, 1-hexene, 1-heptene, 1-octene, 1-nonene, and 1-decene; a diolefin such as 1,5-hexadiene, 1,4-hexadiene, 1,4-pentadiene, 1,7-octadiene, 1,8-nonadiene, 1,9-decadiene, 4-methyl-1,4-hexadiene, 5-methyl-1,4-hexadiene, 7-methyl-1,6-octadiene, 5-ethylidene-2-norbornene, dicyclopentadiene, 5-vinyl-2-norbornene, 5-methyl-2-norbornene, norbornadiene, 5-methylene-2-norbornene, 1,5-cyclooctadiene, 5,8-endomethylenehexahydronaphthalene, 1,3-butadiene, isoprene, 1,3-hexadinene, 1,3-octadiene, 1,3-cyclooctadiene, and 1,3-cyclohexadiene; a cyclic olefin such as norbornene, 5-methylnorbornene, 5-ethylnorbornene, 5-butylnorbornene, 5-phenylnorbornene, 5-benzylnorbornene, tetracyclododecene, tricyclodecene, tricycloundecene, pentacyclopentadecene, pentacyclohexadecene, 8-methyltetracyclododecene, 8-ethyltetracyclododecene, 5-acetylnorbornene, 5-acetyloxynorbornene, 5-methoxycarbonylnorbornene, 5-ethoxycarbonylnorbornene, 5-methyl-5-methoxycarbonylnorbornene, 5-cyanonorbornene, 8-methoxycarbonyltetracyclododecene, 8-methyl-8-tetracyclododecene, and 8-cyanotetracyclododecene; an alkenylalicyclic compound such as vinylcyclohexane; and a combination of two or more thereof.

Examples of an olefin polymer produced by the polymer production process of the present invention are a homopolymer of the above respective olefins such as an ethylene homopolymer, a propylene homopolymer, a 1-butene homopolymer, and 1-hexene homopolymer; a copolymer of ethylene with an α-olefin having 3 to 20 carbon atoms such as an ethylene-propylene copolymer, an ethylene-1-butene copolymer, an ethylene-1-hexene copolymer, an ethylene-1-octene copolymer, and an ethylene-vinylcyclohexane copolymer; a copolymer of propylene with an α-olefin having 4 to 20 carbon atoms such as a propylene-1-butene copolymer, a propylene-1-hexene copolymer, and a propylene-vinylcyclohexane copolymer; and a copolymer of ethylene, propylene and an α-olefin having 4 to 20 carbon atoms such as an ethylene-propylene-1-butene copolymer, an ethylene-propylene-1-hexene copolymer, and an ethylene-propylene-1-octene copolymer.

According to the present invention, there can be produced an olefin polymer containing an olefin polymer carrying the structure represented by formula [4] at its terminal:

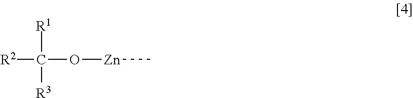

wherein R¹, R² and R³ are the same as those in formula [2], respectively; and ——— is a binding site with the olefin polymer.

The above olefin polymer containing an olefin polymer carrying the structure represented by formula [4] at its terminal:
has a molecular weight distribution (Mw/Mn) of preferably 1.5 to less than 9.0;
can be used as a polymer having an improved property or a new capability;
can be used as a modifier for other polymer; and
can be oxidized by contacting it with an oxidizing agent according to an oxidation method known in the art, thereby producing an olefin polymer carrying a hydroxyl group at its end.

Examples of the oxidizing agent are air, oxygen and ozone. Among them, preferred is oxygen. In order to promote the oxidation, the oxidation product is preferably further reacted with hydrogen peroxide.

### EXAMPLE

The present invention is explained in more detail with reference to the following Examples, which do not limit the present invention.

### Example 1

To a 25 mL flask purged with nitrogen gas was charged 0.388 mL (containing 0.80 mmol of diethyl zinc) of a toluene solution (concentration: 2.06 mmol/mL) of diethyl zinc (zinc compound). Then, 2.0 mL (containing 0.80 mmol of perfluoro-tert-butyl alcohol) of a toluene solution (concentration: 0.40 mmol/mL) of perfluoro-tert-butyl alcohol (halogenated alcohol) was added thereto drop-wise at room temperature. The resultant mixture was stirred for 3 minutes, thereby obtaining a toluene solution of a zinc atom-containing compound, the toluene solution containing 0.80 mmol of a zinc atom.

A 400 mL-inner volume autoclave equipped with a stirrer was dried in a vacuum, and then was purged with argon. To the autoclave were charged 180 mL of toluene (solvent) and 20 mL of 1-hexene (comonomer), and the autoclave was heated up to 80° C. Ethylene was fed thereto while regulating ethylene pressure therein at 0.6 MPa. To the autoclave were added 0.25 mL (containing 0.25 mmol of triisobutylaluminum) of a toluene solution (concentration: 1.0 M) of triisobutylaluminum (organoaluminum compound), 0.5 mL (containing 0.05 μmol of racemic ethylenebis(indenyl)zirconium dichloride) of a toluene solution (concentration: 1.0 μmol/mL) of racemic ethylenebis(1-indenyl)zirconium dichloride (transition metal compound), and all the above toluene solution of a zinc atom-containing compound were added to the autoclave, in this order, thereby initiating polymerization.

The polymerization was continued at 80° C. for 30 minutes, thereby obtaining 2.0 g of an ethylene-1-hexene copolymer. Its polymerization activity was found to be 8.0×10⁷ g/mol-Zr/hour. The copolymer was found to have SCB (short-chain branch number per 1,000 carbon atoms) of 15.55; melting temperature of 110.4° C.; intrinsic viscosity ([η]) of 0.58 dl/g; weight average molecular weight (Mw) of 24,000; and molecular weight distribution (Mw/Mn, Mn: number average molecular weight) of 2.5. An amount of a zinc atom existing in the terminal structure represented by formula [4] was found to be 0.66/1,000 C. Results are shown in Table 1.

Also, the copolymer was found to contain 0.000 (zero) per 1,000 carbon atoms of a vinylene group, 0.195 per 1,000 carbon atoms of a vinyl group, 0.095 per 1,000 carbon atoms of a vinylidene group, and 1.030 per 1,000 carbon atoms of an initiation terminal, as shown in Table 1, wherein the “initiation terminal” means an amount of a methyl group-carrying terminal linking to one terminal of the copolymer main chain.

The above SCB corresponds to the number of 1-hexene units per 1,000 carbon atoms contained in the ethylene-1-hexene copolymer, and was measured by infrared spectroscopy using an infrared spectrometer, EQUINOX 55, manufactured by Bruker Corporation, based on characteristic absorptions (1,378 cm⁻¹ to 1,303 cm⁻¹) of a butyl group contained in the 1-hexene unit.

The above melting temperature was measured using a differential scanning calorimeter, DIAMOND DSC, manufactured by Perkin Elmer, by a method comprising steps of:

(1) keeping about 10 mg of a sample at 150° C. for 5 minutes in a nitrogen atmosphere;

(2) cooling the sample down to 20° C. at a cooling rate of 5° C./minute, and keeping the sample for 2 minutes;

(3) heating the sample up to 150° C. at a heating rate of 5° C./minute, thereby obtaining an endothermic curve; and

(4) considering a peak temperature in the endothermic curve as a melting temperature of the sample.

The above intrinsic viscosity was measure using tetralin as a solvent at 135° C. with an Ubbellohde viscometer.

The above average molecular weight and molecular weight distribution were measured by gel permeation chromatography (GPC) under the following conditions, a calibration curve being prepared using standard polystyrene:
equipment: type 150C, manufactured by Millipore Waters Co.;
column: TSK-GEL GMH-HT, 7.5 mm (inner diameter)×600 mm (length)×2 columns;
measurement temperature: 140° C. or 152° C.;
solvent: ortho-dichlorobenzene; and
measurement concentration: 5 mg/5 ml.

The above amount of a zinc atom existing in the terminal structure represented by formula [5], per 1,000 carbon atoms contained in the ethylene-1-hexene copolymer was measured by a method comprising steps of:

(1) terminating the polymerization with deuterated methanol (CH₃OD), thereby substituting a zinc atom existing in the terminal structure represented by formula [4] with a deuterium atom;

(2) measuring a ¹³C-NMR spectrum of the deuterated copolymer under the following conditions; and
¹³C-NMR equipment: AVANCE 600 manufactured by
Bruker Corporation;
measurement solvent: mixed solvent of 75 parts by volume of 1,2-dichlorobenzene and 25 parts by volume of 1,2-dichlorobenzene-d4;
measurement temperature: 130° C.;
measurement method: proton-decoupling method;
pulse width: 45 degree;
pulse repetition time: 4 seconds;
internal chemical shift reference: tetramethylsilane; and
window function; positive exponential function,

(3) calculating an amount of the deuterated terminal structure by a method comprising steps of (i) integrating the obtained ¹³C-NMR spectrum provided that its region of 5 to 50 ppm is assigned to be 1,000, and (ii) measuring a value of integral of a peak observed at 22.7 ppm, which value of integral corresponds to the amount of a zinc atom existing in the terminal structure represented by formula [5], per 1,000 carbon atoms contained in the ethylene-1-hexene copolymer, and which peak corresponds to the following underlined carbon atoms,
(1S-d)-CH₂—CH₂—CH₂D (triplet, 13.8 ppm, 13.7 ppm, 13.5 ppm, J_{CD}=19 Hz)
(2S-d)-CH₂—CH₂—CH₂D (singlet, 22.7 ppm)
(3S-d)-CH₂—CH₂—CH₂D (singlet, 32.1 ppm).

In the above ¹³C-NMR spectrum, observed was no methylene or methine group linking to a deuterium atom.

Each of the above amounts of the vinylene group, vinyl group and vinylidene group, per 1,000 carbon atoms, contained in the copolymer was obtained by a ¹H-NMR method, measured under the following conditions, according to the following calculation method:

### ¹H-NMR Measurement Conditions

apparatus: AVANCE 600, manufactured by Bruker Corporation;
measurement solvent: 1,1,2,2-tetrachloroethane-d2;
measurement temperature: 130° C.;
pulse width: 30 degree;
pulse repetition time: 4 seconds;
chemical shift reference: 1,1,2,2-tetrachloro ethane-d2 (6.0 ppm).

### Calculation Method

The method comprises steps of (i) integrating a ¹H-NMR spectrum, provided that its region of 0.3 to 3.0 ppm is assigned to be 1,000, and (ii) assigning integral values of peaks observed in the region “5.15 to 5.53 ppm”, “4.92 to 5.12 ppm” and “4.70 to 4.75 ppm”, to “vinylene group”, “vinyl group” and “vinylidene group”, respectively.

### Example 2

Example 1 was repeated except that the polymerization temperature of 80° C. was changed to 110° C. Results are shown in Table 1.

### Example 3

Example 1 was repeated except that the toluene solution of triisobutylaluminum was changed to 0.25 mL (containing 0.25 mmol of triethylaluminum) of a toluene solution (concentration: 1.0 M) of triethylaluminum. Results are shown in Table 1.

### Example 4

Example 1 was repeated except that the toluene solution of triisobutylaluminum was changed to 0.25 mL (containing 0.25 mmol of tri-n-octylaluminum) of a toluene solution (concentration: 1.0 M) of tri-n-octylaluminum. Results are shown in Table 1.

### Example 4.1

Example 1 was repeated except that the polymerization solvent was changed from 180 mL of toluene to 180 mL of hexane. Results are shown in Table 1.

### Example 4.2

Example 1 was repeated except that (i) 20 mL of 1-hexene was changed to 40 mL thereof, and (ii) the amount of polymerization solvent (toluene) was changed from 180 mL to 160 mL. Results are shown in Table 1.

### Example 4.3

Example 1 was repeated except that (i) 20 mL of 1-hexene was changed to 60 mL thereof, and (ii) the amount of polymerization solvent(toluene) was changed from 180 mL to 140 mL. Results are shown in Table 1.

### Comparative Example 1

### (1) Preparation of bis(pentafluorophenoxy)zinc

It was prepared according to a method disclosed in Example 1 of JP2001-181327A (corresponding to US2001/0020075A), as follows:

To a 100 mL-flask purged with nitrogen gas were charged 50 mL of hexane and 4.85 mL (containing 10 mmol of diethyl zinc) of a hexane solution (concentration: 2.06 mmol/mL) of diethyl zinc. The resultant mixture was cooled down to −78° C., and 20 ml (containing 20 mmol of pentafluorophenol) of a hexane solution (concentration: 1 mmol/mL) of pentafluorophenol was added slowly thereto drop-wide. The mixture was raised in its temperature up to room temperature, and then was agitated for 4 hours. A white solid formed was filtered off with a glass filter, and was dried under reduced pressure, thereby obtaining 3.64 g of bis(pentafluorophenoxy)zinc as a white solid.

### (2) Polymerization

Example 1 was repeated except that the toluene solution of a zinc atom-containing compound was changed to 340.9 mg (0.79 mmol) of above-prepared bis(pentafluorophenoxy)zinc, thereby obtaining 1.0 g of an ethylene-1-hexene copolymer. Its polymerization activity was found to be 4.0×10⁷ g/mol-Zr/hour. The copolymer was found to have SCB (short-chain branch number per 1,000 carbon atoms) of 16.41; intrinsic viscosity ([η]) of 1.09 dl/g; and weight average molecular weight (Mw) of 59,000; molecular weight distribution (Mw/Mn, Mn: number average molecular weight) of 2.4; and was found to contain no zinc atom liked to its terminal. Results are shown in Table 1.

### Comparative Example 2

Example 1 was repeated except that (i) the organoaluminum compound was changed to 0.54 mL of MAO-3A manufactured by Tosoh Akzo Corporation, and (ii) the toluene solution of a zinc atom-containing compound was changed to 0.388 mL (containing 0.80 mmol of diethyl zinc) of a hexane solution (concentration: 2.06 mmol/mL) of diethyl zinc, thereby obtaining 10.8 g of an ethylene-1-hexene copolymer. Its polymerization activity was found to be 4.3×10⁸ g/mol-Zr/hour. The copolymer was found to have SCB (short-chain branch number per 1,000 carbon atoms) of 19.8; melting temperature of 108.0° C.; intrinsic viscosity ([η]) of 0.78 dl/g; weight average molecular weight (Mw) of 43,000; and molecular weight distribution (Mw/Mn, Mn: number average molecular weight) of 2.8, and was found to contain a zinc atom liked to its terminal in an amount of 0.39/1,000 C. Above MAO-3A is a toluene solution (concentration: 1.85 M), and 0.54 mL thereof contains 1.0 mmol of an organoaluminum compound. Results are shown in Table 1.

### Example 5

Example 1 was repeated except that (i) the polymerization temperature of 80° C. was changed to 70° C., and (ii) the transition metal compound was changed to 0.2 mL (containing 0.2 μmol of bis(n-butylcyclopentadienyl)zirconium dichloride) of a toluene solution (concentration: 1.0 μmol/mL) of bis(n-butylcyclopentadienyl)zirconium dichloride (transition metal compound), thereby obtaining 4.4 g of an ethylene-1-hexene copolymer. Its polymerization activity was found to be 4.4×10⁷ g/mol-Zr/hour. The copolymer was found to have SCB (short-chain branch number per 1,000 carbon atoms) of 6.26; melting temperature of 122.0° C.; weight average molecular weight (Mw) of 69,000; and molecular weight distribution (Mw/Mn, Mn: number average molecular weight) of 5.1. An amount of a zinc atom existing in the terminal structure represented by formula [4] was found to be 0.43/1,000 C. Results are shown in Table 1.

### Example 6

Example 1 was repeated except that the transition metal compound was changed to 0.2 mL (containing 0.2 μmol of bis(n-butylcyclopentadienyl)zirconium dichloride) of a toluene solution (concentration: 1.0 μmol/mL) of bis(n-butylcyclopentadienyl)zirconium dichloride (transition metal compound). Results are shown in Table 1.

### Example 7

Example 1 was repeated except that (i) the polymerization temperature of 80° C. was changed to 90° C., and (ii) the transition metal compound was changed to 0.2 mL (containing 0.2 μmol of bis(n-butylcyclopentadienyl)zirconium dichloride) of a toluene solution (concentration: 1.0 μmol/mL) of bis(n-butylcyclopentadienyl)zirconium dichloride (transition metal compound). Results are shown in Table 1.

### Example 8

Example 1 was repeated except that (i) the polymerization temperature of 80° C. was changed to 100° C., and (ii) the transition metal compound was changed to 0.2 mL (containing 0.2 μmol of bis(n-butylcyclopentadienyl)zirconium dichloride) of a toluene solution (concentration: 1.0 μmol/mL) of bis(n-butylcyclopentadienyl)zirconium dichloride (transition metal compound). Results are shown in Table 1.

### Example 8.1

Example 1 was repeated except that (i) the polymerization temperature was changed from 80° C. to 110° C., and (ii) the transition metal compound was changed to 0.2 mL (containing 0.2 μmol of bis(n-butylcyclopentadienyl)zirconium dichloride) of a toluene solution (concentration: 1.0 μmol/mL) of bis(n-butylcyclopentadienyl)zirconium dichloride (transition metal compound). Results are shown in Table 1.

TABLE 1

| | Example | | | | | |
|---|---|---|---|---|---|---|
| | 1 | 2 | 3 | 4 | 5 | 6 |
| Zn-containing compound (mmol-Zn used) | | | | | | |
| Prepared in Example 1 | 0.80 | 0.80 | 0.80 | 0.80 | 0.80 | 0.80 |
| Transition metal compound (μmol used) | | | | | | |
| EIZC | 0.05 | 0.05 | 0.05 | 0.05 | | |
| NBZ | | | | | 0.2 | 0.2 |
| Organo aluminum compound (mmol used) | | | | | | |
| Triisobutylaluminum | 0.25 | 0.25 | | | 0.25 | 0.25 |
| Triethylaluminum | | | 0.25 | | | |
| Tri-n-octylaluminum | | | | 0.25 | | |
| Polymerization temperature (° C.) | 80 | 110 | 80 | 80 | 70 | 80 |
| Ethylene-1-hexene copolymer | | | | | | |
| Yield (g) | 2.0 | 9.2 | 3.1 | 7.4 | 4.4 | 4.5 |
| Activity (g/mol-Zr/h) | 8.0 × 10⁷ | 3.7 × 10⁸ | 1.2 × 10⁸ | 3.0 × 10⁸ | 4.4 × 10⁷ | 4.5 × 10⁷ |
| SCB (/1,000C) | 15.55 | 19.11 | 19.42 | 21.45 | 6.26 | 9.15 |
| Melting temperature (° C.) | 110.4 | — | 105.8, 108 | 105.1 | 122.0 | 119.4 |
| [η] (dl/g) | 0.58 | 0.36 | 0.38 | 0.49 | — | 0.78 |
| Mw | 24,000 | 15,000 | 16,000 | 23,000 | 69,000 | 58,000 |
| Mw/Mn | 2.5 | 2.2 | 2.3 | 2.5 | 5.1 | 9.0 |
| Amount of terminal Zn (/1,000C) | 0.66 | 0.82 | 0.85 | 0.56 | 0.43 | 1.27 |

| | Example | | | Comparative Example | |
|---|---|---|---|---|---|
| | 7 | 8 | 8.1 | 1 | 2 |
| Zn-containing compound (mmol-Zn used) | | | | | |
| Prepared in Example 1 | 0.80 | 0.80 | 0.80 | | |
| Prepared in Comparative Example 1 | | | | 0.79 | |
| Zn (C₂H₅)₂ | | | | | 0.80 |
| Transition metal compound (μmol used) | | | | | |
| EIZC | | | | 0.05 | 0.05 |
| NBZ | 0.2 | 0.2 | 0.2 | | |
| Organo aluminum compound (mmol used) | | | | | |
| Triisobutylaluminum | 0.25 | 0.25 | 0.25 | 0.25 | |
| MMAO-3A | | | | | 1.0 |
| Polymerization temperature (° C.) | 90 | 100 | 110 | 80 | 80 |
| Ethylene-1-hexene copolymer | | | | | |
| Yield (g) | 2.8 | 1.8 | 1.7 | 1.0 | 10.8 |
| Activity (g/mol/h) | 2.8 × 10⁷ | 1.8 × 10⁷ | 1.7 × 10⁷ | 4.0 × 10⁷ | 43 × 10⁸ |
| SCB (/1,000C) | 9.82 | 9.99 | 10.53 | 16.41 | 19.77 |
| Melting temperature (° C.) | 119.7 | 121.2 | 117.6 | | 108.0 |
| [η] (dl/g) | 0.63 | 0.71 | 0.53 | 1.09 | 0.78 |
| Mw | 38,000 | 43,000 | 24,000 | 59,000 | 43,000 |
| Mw/Mn | 7.0 | 6.0 | 3.7 | 2.4 | 2.8 |
| Amount of terminal Zn (/1,000C) | 1.63 | 0.98 | 1.253 | 0 | 0.39 |

| | Example | | |
|---|---|---|---|
| | 4.1 | 4.2 | 4.3 |
| Zn-containing compound (mmol-Zn used) | | | |
| Prepared in Example 1 | 0.80 | 0.80 | 0.80 |
| Transition metal compound (μmol used ) | | | |
| EIZC | 0.05 | 0.05 | 0.05 |
| NBZ | | | |
| PIZC | | | |
| Organo aluminum compound (mmol used) | | | |
| Triisobutylaluminum | 0.25 | 0.25 | 0.25 |
| MMAO-3A | | | |
| Polymerization temperature (° C.) | 80 | 80 | 80 |
| Ethylene-1-hexene copolymer | | | |
| Yield (g) | 1.6 | 5.6 | 2.3 |
| Activity (g/mol-Zr/h) | 6.4 × 10⁷ | 2.2 × 10⁸ | 9.2 × 10⁷ |
| SCB (/1,000C) | 27.04 | 27.11 | 38.77 |
| Melting temperature (° C.) | 94.6 | 78.3, 90.4 | 58.2, 77.5 |
| [η] (dl/g) | 0.32 | 0.45 | 0.51 |
| Mw | 13,000 | 21,000 | 20,000 |
| Mw/Mn | 2.2 | 3.1 | 3.0 |
| Amount of terminal Zn (/1,000C) | 1.01 | 0.54 | 0.48 |

| | Example | | | | | | |
|---|---|---|---|---|---|---|---|
| | 1 | 2 | 3 | 4 | 4.1 | 4.2 | 4.3 |
| Vinylene (per 1,000C) | 0.000 | 0.050 | 0.000 | 0.000 | 0.070 | 0.115 | 0.195 |
| Vynyl (per 1,000C) | 0.195 | 0.320 | 0.170 | 0.170 | 0.140 | 0.247 | 0.240 |
| Vinylidene (per 1,000C) | 0.095 | 0.075 | 0.085 | 0.085 | 0.085 | 0.031 | 0.036 |
| Initiation terminal | 1.030 | 1.590 | 1.410 | 1.00 | 1.680 | 1.058 | 0.970 |
| (per 1,000C) | | | | | | | |

| | |
|---|---|
| Example | Comparative Example |

| | 5 | 6 | 7 | 8 | 8.1 | 1 | 2 |
|---|---|---|---|---|---|---|---|
| Vinylene (per 1,000C) | 0.000 | ND | 0.000 | 0.000 | 0.089 | 0.000 | 0.000 |
| Vynyl (per 1,000C) | 0.000 | ND | 0.070 | 0.065 | 0.346 | 0.140 | 0.145 |
| Vinylidene (per 1,000C) | 0.075 | ND | 0.090 | 0.080 | 0.016 | 0.070 | 0.070 |
| Initiation terminal | 0.850 | 1.600 | 2.050 | 1.300 | 1.727 | 0.330 | 0.760 |
| (per 1,000C) | | | | | | | |

EIZC: racemic ethylenebis(1-indenyl)zirconium dichloride
NZB: bis(n-butylcyclopentadienyl)zirconium dichloride

### Example 10

A 400 mL-inner volume autoclave equipped with a stirrer was dried in a vacuum, and then was purged with argon. To the autoclave were charged 40 mL of toluene (solvent) and 80 g of propylene, and the autoclave was heated up to 80° C. To the autoclave were added 0.50 mL (containing 0.50 mmol of triisobutylaluminum) of a toluene solution (concentration: 1.0 M) of triisobutylaluminum, 0.2 mL (containing 0.2 μmol of racemic ethylenebis(indenyl)zirconium dichloride) of a toluene solution (concentration: 1.0 μmol/mL) of racemic ethylenebis(1-indenyl)zirconium dichloride, and all the toluene solution of a zinc atom-containing compound prepared in Example 1 were added to the autoclave, in this order, thereby initiating polymerization.

The polymerization was continued at 80° C. for 30 minutes, thereby obtaining 0.78 g of a propylene polymer. Its polymerization activity was found to be 7.8×10⁶ g/mol-Zr/hour. The polymer was found to have intrinsic viscosity ([η]) of 0.13 dl/g; weight average molecular weight (Mw) of 8,200; and molecular weight distribution (Mw/Mn, Mn: number average molecular weight) of 2.1. An amount of a zinc atom existing in the terminal structure represented by formula [4] was found to be 1.17/1,000 C. Results are shown in Table 2.

### Example 11

Example 10 was repeated except that 0.2 mL of the toluene solution of racemic ethylenebis(1-indenyl)zirconium dichloride was changed to 2.0 mL. Results are shown in Table 2.

TABLE 2

| | Example | |
|---|---|---|
| | 10 | 11 |
| Zn-containing compound (mmol-Zn used) | | |
| Prepared in Example 1 | 0.80 | 0.80 |
| Transition metal compound (μmol used) | | |
| EIZC | 0.2 | 2.0 |
| Organo aluminum compound (mmol used) | | |
| Triisobutylaluminum | 0.50 | 0.50 |
| Polymerization temperature (° C.) | 80 | 80 |
| Propylene homopolymer | | |
| Yield (g) | 0.78 | 39.7 |
| Activity (g/mol/h) | 7.8 × 10⁶ | 4.0 × 10⁷ |
| Melting temperature (° C.) | — | 111.5 |
| [η] (dl/g) | 0.13 | 0.17 |
| Mw | 8,200 | 11,000 |
| Mw/Mn | 2.1 | 2.4 |
| Amount of terminal Zn (/1,000 C) | 1.17 | 0.73 |

### Example 12

To a 25 mL flask purged with nitrogen gas was charged 0.485 mL (containing 1.0 mmol of diethyl zinc) of a toluene solution (concentration: 2.06 mmol/mL) of diethyl zinc. Then, 2.5 mL (containing 1.0 mmol of perfluoro-tert-butyl alcohol) of a toluene solution of perfluoro-tert-butyl alcohol was added thereto drop-wise at room temperature. The resultant mixture was stirred for 3 minutes, thereby obtaining a toluene solution of a zinc atom-containing compound, the toluene solution containing 1.0 mmol of a zinc atom.

A 400 mL-inner volume autoclave equipped with a stirrer was dried in a vacuum, and then was purged with argon. To the autoclave were charged 190 mL of toluene and 10 mL of 1-hexene, and the autoclave was heated up to 30° C. Ethylene was fed thereto while regulating ethylene pressure therein at 0.6 MPa. To the autoclave were added and all the above toluene solution of a zinc atom-containing compound, and 1.0 mL (containing 10 μmol of bis(pentamethylcyclopentadienyl)zirconium dimethyl) of a toluene solution (concentration: 1.0 μmol/mL) of bis(pentamethylcyclopentadienyl)zirconium dimethyl were added to the autoclave, in this order, thereby initiating polymerization.

The polymerization was continued at 30° C. for 30 minutes, thereby obtaining 0.75 g of an ethylene-1-hexene copolymer. Its polymerization activity was found to be 1.5×10⁵ g/mol-Zr/hour. The copolymer was found to have SCB (short-chain branch number per 1,000 carbon atoms) of 2.64; melting temperature of 134.6° C.; intrinsic viscosity ([η]) of 0.65 dl/g; weight average molecular weight (Mw) of 32,000; and molecular weight distribution (Mw/Mn, Mn: number average molecular weight) of 2.2. An amount of a zinc atom existing in the terminal structure represented by formula [4] was found to be 0.33/1,000 C. Results are shown in Table 3.

### Example 13

Example 12 was repeated except that the polymerization temperature of 30° C. was changed to 50° C. Results are shown in Table 3.

### Example 14

Example 12 was repeated except that the polymerization temperature of 30° C. was changed to 70° C. Results are shown in Table 3.

### Example 15

Example 12 was repeated except that the polymerization temperature of 30° C. was changed to 90° C. Results are shown in Table 3.

### Example 16

Example 12 was repeated except that (i) the toluene solution of a zinc atom-containing compound was changed in its amount so as to contain 0.25 mmol of a zinc atom, and (ii) the polymerization temperature of 30° C. was changed to 70° C. Results are shown in Table 3.

### Example 17

Example 12 was repeated except that (i) the toluene solution of a zinc atom-containing compound was changed in its amount so as to contain 0.50 mmol of a zinc atom, and (ii) the polymerization temperature of 30° C. was changed to 70° C. Results are shown in Table 3.

### Example 18

Example 12 was repeated except that (i) the toluene solution of a zinc atom-containing compound was changed in its amount so as to contain 2.0 mmol of a zinc atom, and (ii) the polymerization temperature of 30° C. was changed to 70° C. Results are shown in Table 3.

### Example 19

Example 12 was repeated except that (i) the polymerization temperature of 30° C. was changed to 70° C., and (ii) the polymerization time of 30 minutes was changed to 5 minutes. Results are shown in Table 3.

### Example 20

Example 12 was repeated except that (i) the polymerization temperature of 30° C. was changed to 70° C., and (ii) the polymerization time of 30 minutes was changed to 60 minutes. Results are shown in Table 3.

### Example 21

Example 12 was repeated except that (i) 10 μmol of bis(pentamethylcyclopentadienyl)zirconium dimethyl was changed to 100 μmol thereof, and (ii) the polymerization temperature of 30° C. was changed to 70° C. Results are shown in Table 3.

TABLE 3

| | Example | | | | |
|---|---|---|---|---|---|
| | 12 | 13 | 14 | 15 | 16 |
| Zn-containing compound (mmol-Zn used) | | | | | |
| Prepared in Example 12 | 1.0 | 1.0 | 1.0 | 1.0 | 0.25 |
| Transitionmetal compound (μmol used) | | | | | |
| MCZM | 10 | 10 | 10 | 10 | 10 |
| Polymerization | | | | | |
| Temperature (° C.) | 30 | 50 | 70 | 90 | 70 |
| Time (minute) | 30 | 30 | 30 | 30 | 30 |
| Ethylene-1-hexene copolymer | | | | | |
| Yield (g) | 0.75 | 2.5 | 2.8 | 0.6 | 0.55 |
| Activity (g/mol/h) | 1.5 × 10⁵ | 5.0 × 10⁵ | 5.6 × 10⁵ | 1.2 × 10⁵ | 1.1 × 10⁵ |
| SCB (/1,000 C) | 2.64 | 2.39 | 1.92 | 3.76 | 2.15 |
| Melting temperature (° C.) | 134.6 | 135.2 | 134.1 | 132.9 | 133.7 |
| [η] (dl/g) | 0.65 | 0.72 | 0.86 | 0.60 | 1.11 |
| Mw | 32,000 | 36,000 | 45,000 | 22,000 | 60,000 |
| Mw/Mn | 2.2 | 2.3 | 2.1 | 2.2 | 2.2 |
| Amount of terminal Zn (/1,000 C) | 0.33 | 0.30 | 0.33 | 1.07 | 0.17 |
| | Example | | | | |
| | 17 | 18 | 19 | 20 | 21 |
| Zn-containing compound (mmol-Zn used) | | | | | |
| Prepared in Example 12 | 0.50 | 2.0 | 1.0 | 1.0 | 1.0 |
| Transitionmetal compound (μmol used) | | | | | |
| MCZM | 10 | 10 | 10 | 10 | 100 |
| Polymerization | | | | | |
| Temperature (° C.) | 70 | 70 | 70 | 70 | 70 |
| Time (minute) | 30 | 30 | 5 | 60 | 30 |
| Ethylene-1-hexene copolymer | | | | | |
| Yield (g) | 1.4 | 1.7 | 1.2 | 2.5 | 11 |
| Activity (g/mol/h) | 2.8 × 10⁵ | 3.4 × 10⁵ | 1.4 × 10⁵ | 2.5 × 10⁵ | 2.2 × 10⁵ |
| SCB (/1,000 C) | 1.26 | 4.41 | 2.38 | 2.44 | 2.14 |
| Melting temperature (° C.) | 133.3 | 131.5 | 135.3 | 135.6 | 132.6 |
| [η] (dl/g) | 1.23 | 0.39 | 0.68 | 0.66 | 0.89 |
| Mw | 70,800 | 17,000 | 32,000 | 32,000 | 53,000 |
| Mw/Mn | 2.1 | 2.1 | 2.1 | 2.3 | 2.5 |
| Amount of terminal Zn (/1,000 C) | 0.16 | 0.96 | 0.56 | 0.45 | 0.32 |

The zinc atom-containing compound prepared in Example 12 was the same as that prepared in Example 1.
MCZM: bis(pentamethylcyclopentadienyl)zirconium dimethyl

### Comparative Example 3

Example 12 was repeated except that (i) 10 μmol of bis(pentamethylcyclopentadienyl)zirconium dimethyl was changed to 100 μmol thereof, (ii) the polymerization temperature of 30° C. was changed to 70° C., and (iii) the toluene solution of a zinc atom-containing compound was changed to 0.76 mmol of bis(pentafluorophenoxy)zinc prepared in Comparative Example 1.

The polymerization was continued at 70° C. for 30 minutes, thereby obtaining 0.78 g of an ethylene-1-hexene copolymer. Its polymerization activity was found to be 1.6×10⁴ g/mol-Zr/hour. The copolymer was found to have SCB (short-chain branch number per 1,000 carbon atoms) of 1.02; intrinsic viscosity ([η]) of 1.61 dl/g; weight average molecular weight (Mw) of 95,000; and molecular weight distribution (Mw/Mn, Mn: number average molecular weight) of 2.6. An amount of a zinc atom existing in the terminal structure represented by formula [4] was found to be 0 (zero)/1,000 C.

### Comparative Example 4

A 400 mL-inner volume autoclave equipped with a stirrer was dried in a vacuum, and then was purged with argon. To the autoclave were charged 190 mL of toluene and 10 mL of 1-hexene, and the autoclave was heated up to 70° C. Ethylene was fed thereto while regulating ethylene pressure therein at 0.6 MPa. To the autoclave were added 1.0 mL (containing 10 μmol of bis(pentamethylcyclopentadienyl)zirconium dimethyl) of a toluene solution (concentration: 1.0 μmol/mL) of bis(pentamethylcyclopentadienyl)zirconium dimethyl, 0.121 mL (containing 0.25 mmol of diethyl zinc) of a toluene solution (concentration: 2.06 mmol/mL) of diethyl zinc, and 4.0 mL (containing 0.02 mmol of triphenylmethylium tetrakis(pentafluorophenyl)borate) of a toluene solution (concentration: 5 μmol/mL) of triphenylmethylium tetrakis(pentafluorophenyl)borate were added to the autoclave, in this order, thereby initiating polymerization.

The polymerization was continued at 70° C. for 30 minutes, thereby obtaining 3.1 g of an ethylene-1-hexene copolymer. Its polymerization activity was found to be 6.2×10⁵ g/mol-Zr/hour. The copolymer was found to have SCB (short-chain branch number per 1,000 carbon atoms) of 1.93; intrinsic viscosity ([η]) of 0.79 dl/g; weight average molecular weight (Mw) of 38,000; and molecular weight distribution (Mw/Mn, Mn: number average molecular weight) of 2.0. An amount of a zinc atom existing in the terminal structure represented by formula [4] was found to be 0.15/1,000 C.

### Example 21.5

Example 12 was repeated except that (i) perfluoro-tert-butyl alcohol (1.0 mmol) was changed to perfluoro(dimethylethyl)carbinol (2.0 mmol), (ii) amount of diethylzinc (1.0 mmol) was changed to 2.0 mmol, and (iii) the polymerization temperature of 30° C. was changed to 70° C.

The polymerization was continued at 70° C. for 30 minutes, thereby obtaining 1.1 g of an ethylene-1-hexene copolymer. Its polymerization activity was found to be 2.2×10⁵ g/mol-Zr/hour. The copolymer was found to have SCB (short-chain branch number per 1,000 carbon atoms) of 1.4; melting temperature of 132.8° C.; intrinsic viscosity ([η]) of 0.84 dl/g; weight average molecular weight (Mw) of 44,000; and molecular weight distribution (Mw/Mn, Mn: number average molecular weight) of 2.5. An amount of a zinc atom existing in the terminal structure represented by formula [4] was found to be 0.40/1,000 C.

### Example 22

To a 50 mL flask purged with nitrogen gas was charged 0.96 mL (containing 2.0 mmol of diethyl zinc) of a hexane solution (concentration: 2.08 mmol/mL) of diethyl zinc. Then, 2.27 mL (containing 2.0 mmol of perfluoro-tert-butyl alcohol) of a toluene solution (concentration: 0.88 mmol/mL) of perfluoro-tert-butyl alcohol was added thereto drop-wise at room temperature. The resultant mixture was stirred for 3 minutes, thereby obtaining a toluene-hexane mixed solution of a zinc atom-containing compound.

A 500 mL four-necked flask was dried in a vacuum, and then was purged with nitrogen. To the flask was supplied 100 mL of toluene (solvent), and the flask was heated up to 70° C. Ethylene was fed thereto under atmospheric pressure. After stabilizing the system, 0.28 mL (containing 0.25 mmol of triisobutylaluminum) of a toluene solution (concentration: 0.88 M) of triisobutylaluminum, 3.0 mL (containing 0.1 mmol of bis(pentamethylcyclopentadienyl)zirconium dimethyl) of a toluene solution (concentration: 33.3 μmol/mL) of bis(pentamethylcyclopentadienyl)zirconium dimethyl), and all the above toluene-hexane mixed solution of a zinc atom-containing compound were added to the flask, in this order, thereby initiating polymerization. The polymerization was continued at 70° C. for 30 minutes.

The flask was cooled down to room temperature, and then, 10 mL of a polymer-containing suspension liquid was sampled under a nitrogen atmosphere. The sampled suspension liquid was quenched with deuterated methanol (CH₃OD), thereby obtaining 0.446 g of an ethylene polymer. The ethylene polymer was found to have melting temperature of 128.10° C., Mw of 8,200 and Mw/Mn of 3.5.

The above suspension liquid contained in the flask was cooled down to 0° C., and then, a gaseous matter in the flask was replaced with oxygen gas of atmospheric pressure. The flask was stirred at 0° C. for one hour, and 5 mL of a hydrogen peroxide solution (concentration: 35%) was added thereto. The mixture was heated up to room temperature, and then was stirred for 30 minutes. The reaction mixture was supplied with 5 mL of ethanol, and then was poured into 500 mL of ethanol containing 10 mL of hydrochloric acid (1 N), thereby obtaining 5.01 g of a polymer containing an ethylene polymer carrying a hydroxyl group at its one end. Its polymerization activity was found to be 1.0×10⁵ g/mol-Zr/hour. The above polymer containing an ethylene polymer carrying a hydroxyl group at its one end was found to have melting temperature of 128.5° C.; Mw of 8,500; and Mw/Mn of 3.3. An amount of the hydroxyl group-carrying terminal contained in the above ethylene polymer was found to be 0.79/1,000 C.

In Example 22, the above amount of the “hydroxyl group-carrying terminal” per 1,000 carbon atoms was obtained by a ¹³C-NMR method, measured under the following conditions, according to the following calculation method:

### ¹³C-NMR Measurement Conditions

apparatus: AVANCE 600, manufactured by Bruker Corporation;
measurement solvent: mixed solvent of 75 parts by volume of 1,2-dichlorobenzene and 25 parts by volume of 1,2-dichlorobenzene-d4;
measurement temperature: 130° C.;
measurement method: proton-decoupling method;
pulse width: 45 degree;
pulse repetition time: 4 seconds;
chemical shift reference: tetramethylsilane; and
window function; positive exponential function,

### Calculation Method

The method comprises steps of (i) integrating a ¹³C-NMR spectrum, provided that its region of 5 to 50 ppm is assigned to be 1,000, and (ii) assigning an integral value of a peak observed at 63.02 ppm (singlet) to the amount of the “hydroxyl group-carrying terminal” per 1,000 carbon atoms, wherein the peak appearing at 63.02 ppm corresponds to the below underlined carbon atom (C) contained in one terminal of the copolymer, ————CH₂—CH₂-CH₂—OH.

### Example 23

To a 25 mL flask purged with nitrogen gas was charged 0.388 mL (containing 0.80 mmol of diethyl zinc) of a toluene solution (concentration: 2.06 mmol/mL) of diethyl zinc. Then, 2.0 mL (containing 0.80 mmol of perfluorotriethylcarbinol) of a toluene solution (concentration: 0.40 mmol/mL) of perfluorotriethylcarbinol was added thereto drop-wise at room temperature. The resultant mixture was stirred for 3 minutes, thereby obtaining a toluene solution of a zinc atom-containing compound, the toluene solution containing 0.80 mmol of a zinc atom in total.

A 400 mL autoclave equipped with a stirrer was dried in a vacuum, and then was purged with argon. To the autoclave were supplied 198 mL of toluene (solvent) and 2 mL of 1-hexene (comonomer), and the autoclave was heated up to 90° C. There were added thereto ethylene under regulating its pressure at 0.6 MPa, 0.25 mL (containing 0.25 mmol of triisobutylaluminum) of a toluene solution (concentration: 1.0 M) of triisobutylaluminum, 2.0 mL (containing 2.0 μmol of dimethylsilylene(tetramethylcyclopentadienyl)(3-tert-butyl-5-methyl-2-phenoxy)titanium dichloride) of a toluene solution (concentration: 1.0 μmol/mL) of dimethylsilylene(tetramethylcyclopentadienyl)(3-tert-butyl-5-methyl-2-phenoxy)titanium dichloride, and all the above toluene solution of a zinc atom-containing compound, in this order, thereby initiating polymerization.

The polymerization was continued at 90° C. for 30 minutes, thereby obtaining 0.3 g of an ethylene-1-hexene copolymer. Its polymerization activity was found to be 3.0×10⁵ g/mol-Ti/hour. The above copolymer was found to have SCB of 22.08; Mw of 24,780; and Mw/Mn of 2.5. An amount of a zinc atom existing in the terminal structure represented by formula [4] was found to be 0.48/1,000 C.

1. A process for producing an olefin polymerization catalyst, comprising steps of:
(1) contacting 1 part by mol of a zinc compound represented by following formula [1] with more than 0 part by mol to less than 2 parts by mol of a halogenated alcohol represented by following formula [2], thereby forming a zinc atom-containing compound; and
(2) contacting the zinc atom-containing compound with a compound of a transition metal atom of group 3 to 11 of the periodic table of elements and/or its μ-oxo type transition metal compound, and an optional organoaluminum compound;
Zn(L¹)₂ [1]
wherein L1 is a hydrocarbyl group having 1 to 20 carbon atoms, and two L1s are the same as, or different from each other; and 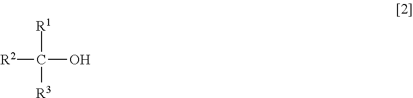
wherein R¹, R² and R³ are a hydrogen atom or a perhalocarbyl group having 1 to 20 carbon atoms, and are the same as, or different from one another; one or more of R¹, R² and R³ are the perhalocarbyl group; and any two or three of R¹, R² and R³ may be linked to one another to form a ring.

2. The process according to claim 1, wherein step (2) contacts the zinc atom-containing compound with the compound of a transition metal atom of group 3 to 11 of the periodic table of elements and the organoaluminum compound.

3. The process according to claim 1, wherein step (2) contacts the zinc atom-containing compound with the compound of a transition metal atom of group 3 to 11 of the periodic table of elements represented by following formula [7] and/or its μ-oxo type transition metal compound:
(L²)_{a-b}M¹(X¹)_{b} [7]
wherein M¹ is a transition metal atom of group 3 to 11 of the periodic table of elements (IUPAC, 1989); L² is a cyclopentadiene-containing anionic group having 5 to 30 carbon atoms, or a hetero atom-containing group, and when two or more L²s exist, they are the same as, or different from one another, and they may be linked to one another directly or through a linking group containing a carbon atom, a silicone atom, a nitrogen atom, an oxygen atom, a sulfur atom or a phosphorus atom; X¹ is a halogen atom, a hydrocarbyl group having 1 to 20 carbon atoms, or a hydrocarbyloxy group having 1 to 20 carbon atoms, and when two or more X¹s exist, they are the same as, or different from one another, and one or more thereof are the hydrocarbyl group having 1 to 20 carbon atoms; a is a valence of M¹; and b is an integer of 1 to (a-1).

4. The process according to claim 1, wherein the zinc atom-containing compound is a compound represented by following formula [3] and/or its associate: 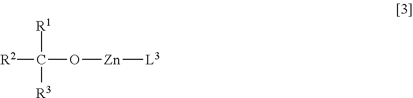
wherein R¹, R² and R³ are the same as those in formula [2], respectively; and L³ is a hydrocarbyl group having 1 to 20 carbon atoms.

5. A process for producing an olefin polymer, comprising a step of polymerizing an olefin in the presence of an olefin polymerization catalyst produced by the process of claim 1.

6. The process according to claim 5, wherein the olefin polymer contains an olefin polymer carrying the terminal structure represented by formula [4] at its terminal: 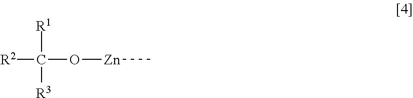
wherein R¹, R² and R³ are the same as those in formula [2], respectively; and ——— is a binding site with the olefin polymer.

7. A process for producing an olefin polymer containing an olefin polymer which carries a hydroxyl group at its end, comprising a step of reacting an olefin polymer produced by the process of claim 6 with oxygen.

8. The process according to claim 7, wherein the olefin polymer containing an olefin polymer which carries a hydroxyl group at its end has a molecular weight distribution (Mw/Mn) of 1.5 to less than 9.0.

9. The process according to claim 7, wherein the olefin polymerization step is carried out in the absence of hydrogen gas.
